(19) United States
(12) Patent Application Publication
(10) Pub. No.: US 2008/0180438 A1
(43) Pub. Date: Jul. 31, 2008

(54) Image generation method, information storage medium, and image generation device

(75) Inventors: Naoya Sasaki, Yokohama-shi (JP); Keita Takahashi, Tokyo (JP)

Correspondence Address: OLIFF & BERRIDGE, PLC, P.O. BOX 320850, ALEXANDRIA, VA, 22320-4850, US

(73) Assignee: NAMCO BANDAI GAMES INC., TOKYO (JP)

(21) Appl. No.: 12/010,062

(22) Filed: Jan. 18, 2008

(30) Foreign Application Priority Data
Jan. 31, 2007 (JP) 2007-020463

(51) Int. Cl. G06T 17/00

(52) U.S. Cl. 345/420

(57) ABSTRACT

An inclusion area which includes a player character is set. The maximum diagonal line of the inclusion area is projected onto an image coordinate system of a game screen, and an Xc axis component projection dimension Lx and a Yc axis component projection dimension Ly are calculated. A projection dimension Lm is selected which is the Xc axis component projection dimension Lx or the Yc axis component projection dimension Ly larger than the other. Photographing conditions of a main virtual camera are set so that a specific ratio is achieved between the projection dimension Lm and a screen width Wx or Wy in the axial component direction of the projection dimension Lm. An image photographed by the main virtual camera is displayed as a main game screen.

Japanese Patent Application No. 2007-20463 filed on Jan. 31, 2007, is hereby incorporated by reference in its entirety.

### BACKGROUND OF THE INVENTION

The present invention relates to a method which causes a computer to generate an image of a three-dimensional virtual space in which a given object is disposed and which is photographed using a virtual camera, and the like.

In recent years, many video games have employed a configuration in which various objects which form a game space, a player object operated by a player, and the like are disposed in a three-dimensional virtual space, and the movement of the object is controlled based on an operation input performed by the player and motion set in advance. A game screen of such games is produced by generating an image of the game space photographed using a virtual camera and synthesizing the resulting image with information (e.g., map, the remaining game time, score, hit point, and the number of remaining bullets) necessary for the game process. Specifically, visual information provided to the player as the game screen is determined depending on the photographing conditions of the virtual camera including the position, line-of-sight direction, and angle of view. Therefore, the operability (i.e., user-friendliness) of the game is affected by the photographing conditions to a large extent.

As technology relating to virtual camera control, technology is known which controls the virtual camera so that a player character and an attack target cursor are positioned within the photographing range (see Japanese Patent No. 3197536, for example).

Various characters appear in a game depending on the type of game. For example, when causing a character having properties similar to those of an elastic body or a rheological object (generic name for a solid which does not follow Hooke's law, a liquid which does not follow Newton's Law of Viscosity, a viscoelastic or plastic object which does not exhibit drag in elastodynamics and hydrodynamics, and the like) to appear, the character expands and contracts freely and does not necessarily have a constant system. When the player operates a character similar to the rheological object, the player must identify the state and the position of the end of the character. Therefore, when using a related-art method which controls the virtual camera merely based on a representative point (e.g., local origin) of the character, a situation may occur in which the end of the expanded character cannot be observed, thereby decreasing operability to a large extent.

### SUMMARY

According to one aspect of the invention, there is provided a method that causes a computer to generate an image of a three-dimensional virtual space photographed by a virtual camera, a given object being disposed in the three-dimensional virtual space, the method comprising:

changing a size and/or a shape of the object;

variably setting an inclusion area that includes the object in the three-dimensional virtual space based on the change in the size and/or the shape of the object;

controlling an angle of view and/or a position of the virtual camera so that the entire inclusion area that has been set is positioned within an image photographed by the virtual camera;

generating an image of the three-dimensional virtual space photographed by the virtual camera; and

displaying the image that has been generated.

### BRIEF DESCRIPTION OF THE SEVERAL VIEWS OF THE DRAWING

FIG. 1 is a system configuration diagram showing a configuration example of a consumer game device.

FIGS. 2A to 2C are views illustrative of the model configuration of a player character.

FIGS. 3A to 3C are schematic views showing the relationship between a movement operation and control of a player character.

FIGS. 4A to 4D are schematic views showing the relationship between an arbitrary expansion operation and control of a player character.

FIGS. 5A to 5D are schematic views showing the relationship between an arbitrary contraction operation and control of a player character.

FIGS. 6A and 6B are schematic views illustrative of a method of setting photographing conditions of a virtual camera.

FIG. 7 is a schematic view illustrative of a sub-virtual camera setting and the concept of a sub-screen display.

FIG. 8 is a functional block diagram showing an example of a functional configuration.

FIG. 9 is a view showing a data configuration example of character control data.

FIG. 10 is a view showing a data configuration example of applied force data.

FIG. 11A is a view showing a data configuration example of head photographing condition candidate data, and FIG. 11B shows an outline of photographing conditions in the data configuration example shown in FIG. 11A.

FIG. 12A is a view showing a data configuration example of event photographing condition candidate data, and FIG. 12B shows an outline of photographing conditions in the data configuration example shown in FIG. 12A.

FIG. 13A is a view showing a data configuration example of image display position setting data, and FIG. 13B shows an outline of the data configuration shown in FIG. 13A.

FIG. 14 is a flowchart illustrative of the flow of a process according to a first embodiment.

FIG. 15 is a flowchart illustrative of the flow of an arbitrary expansion/contraction process.

FIG. 16 is a flowchart illustrative of the flow of an applied force setting process.

FIG. 17 is a flowchart illustrative of the flow of an event virtual camera setting process.

FIG. 18 is a flowchart illustrative of the flow of a main virtual camera setting process.

FIG. 19 is a flowchart illustrative of the flow of a sub-virtual camera setting process.

FIG. 20 is a flowchart illustrative of the flow of a game screen display process.

FIG. 21 is a flowchart illustrative of the flow of an image display switch process.

FIGS. 22A to 22C are views shown in examples of an image photographed by a main virtual camera CM1.

FIGS. 23A to 23C are views showing game screen examples and show a change in screen when switching display between a main game screen W1 and a sub-screen W2.

FIGS. 24A and 24B are views showing game screen examples subsequent to FIG. 23.

FIGS. 25A to 25C are views showing game screen examples and show a change in screen when switching display between a main game screen W1 and a sub-screen W4.

FIG. 26 is a configuration diagram showing an example of a hardware configuration.

FIG. 27 is a flowchart illustrative of the flow of a screen display switch process according to a modification.

FIG. 28 is a system configuration diagram showing a modification of a configuration example of a consumer game device.

### DETAILED DESCRIPTION OF THE EMBODIMENT

The invention may implement appropriate virtual camera control which facilitates the operation of the player when operating an expandable character similar to an elastic body or a rheological object.

According to one embodiment of the invention, there is provided a method that causes a computer to generate an image of a three-dimensional virtual space photographed by a virtual camera, a given object being disposed in the three-dimensional virtual space, the method comprising:

changing a size and/or a shape of the object;

variably setting an inclusion area that includes the object in the three-dimensional virtual space based on the change in the size and/or the shape of the object;

controlling an angle of view and/or a position of the virtual camera so that the entire inclusion area that has been set is positioned within an image photographed by the virtual camera;

generating an image of the three-dimensional virtual space photographed by the virtual camera; and

displaying the image that has been generated.

According to another embodiment of the invention, there is provided an image generation device that generates an image of a three-dimensional virtual space photographed by a virtual camera, a given object being disposed in the three-dimensional virtual space, the image generation device comprising:

an object change control section that changes a size and/or a shape of the object;

an inclusion area setting section that variably sets an inclusion area that includes the object in the three-dimensional virtual space based on the change in the size and/or the shape of the object;

a virtual camera control section that controls an angle of view and/or a position of the virtual camera so that the entire inclusion area that has been set is positioned within an image photographed by the virtual camera;

an image generation section that generates an image of the three-dimensional virtual space photographed by the virtual camera; and

a display control section that displays the image that has been generated.

According to the above configuration, the size and/or the shape of the given object can be arbitrarily changed. As a result, the inclusion area that includes the changed object can be set, and the virtual camera can be controlled so that the entire inclusion area is positioned within the photographed image. Therefore, if the image photographed by the virtual camera is displayed as a game image, an expandable character similar to an elastic body or a rheological object can be entirely displayed even if the character expands/contracts or deformed into infinite form. This allows the player to always observe the ends of the operation target character so that operability increases.

This is particularly effective when the given character is a string-shaped object and the entire character (object) moves accompanying the movement of the ends of the character, for example. Specifically, if the ends of the character are not displayed on the game screen, operability is impaired to a large extent.

In the method according to this embodiment, the method may further include:

determining whether a ratio of a vertical dimension of the inclusion area that has been set to a vertical dimension of the image photographed by the virtual camera is larger or smaller than a ratio of a horizontal dimension of the inclusion area to a horizontal dimension of the image photographed by the virtual camera; and

controlling the angle of view and/or the position of the virtual camera so that the ratio that has been determined to be larger than the other is a specific ratio.

According to the above configuration, the virtual camera can be controlled so that the given character is photographed to be positioned within the image photographed by the virtual camera, irrespective of whether the character is long either vertically or horizontally with respect to the photographing range of the virtual camera.

In the method according to this embodiment,

the inclusion area may be a rectangular parallelepiped; and

the determination may include: determining the ratio that is larger than the other based on vertical and horizontal dimensions of each of diagonal lines of the inclusion area in the image photographed by the virtual camera or a ratio of the vertical and horizontal dimensions of each of the diagonal lines to vertical and horizontal dimensions of the image photographed by the virtual camera.

According to the above configuration, the dimension (representative dimension) of the given character can be calculated using a simple process. When the character is an expandable character, calculating load relating to operation control increases as the character expands to a larger extent. An increase in calculating load can be reduced by reducing calculating load relating to virtual camera control so that the response of the entire process can be maintained.

In the method according to this embodiment, the method may further include:

controlling a view point direction of the virtual camera so that a specific position of the inclusion area is located at a specific position of the image photographed by the virtual camera.

According to the above configuration, the position of the character within the image photographed by the virtual camera can be specified to a certain extent. Therefore, even if the character expands or contracts, a situation in which screen sickness (i.e., symptom in which the player becomes dizzy when continuously watching a screen in which a large amount of movement occurs) can be prevented so that an environment in which the player can easily operate the character is realized.

In the method according to this embodiment, the method may further include:

controlling the angle of view and/or the position of the virtual camera at a speed lower than a change speed of the size and/or the shape of the object.

According to the above configuration, when the object has been changed, the angle of view and/or the position of the virtual camera changes more slowly as compared with the object. Therefore, a rapid change in screen or angle of view can be prevented to achieve a more stable and user-friendly display screen.

In the method according to this embodiment,

the object may be an expandable string-shaped object; and

the method may further include expanding/contracting the object.

According to the above configuration, since the object is an expandable string-shaped object, the character can be controlled while effectively utilizing properties similar to those of an elastic body or a rheological object.

In the method according to this embodiment, the method may further include:

moving an end of the object based on a direction operation input, and moving the string-shaped object so that the entire object moves accompanying the movement of the end; and

variably setting the inclusion area corresponding to a current shape of the string-shaped object that has been moved.

According to the above configuration, since the ends of the object are moved and the entire object is moved accompanying the movement of the ends of the object, movement control utilizing the properties of the character similar to an elastic body or a rheological object can be achieved. Moreover, the inclusion area can be variably set corresponding to the current shape of the string-shaped object.

According to another embodiment of the invention, there is provided a computer-readable information storage medium storing a program that causes a computer to execute the above method.

The term “information storage medium” used herein includes a magnetic disk, an optical disk, an IC memory, and the like.

Embodiments of the invention are described below with reference to the drawings. Note that the embodiments described below do not in any way limit the scope of the invention defined by the claims laid out herein. Note that all elements of the embodiments described below should not necessarily be taken as essential requirements for the invention.

### First Embodiment

A first embodiment to which the invention is applied is described below taking an example of a video game in which an expandable character appears.

### Configuration of Game Device

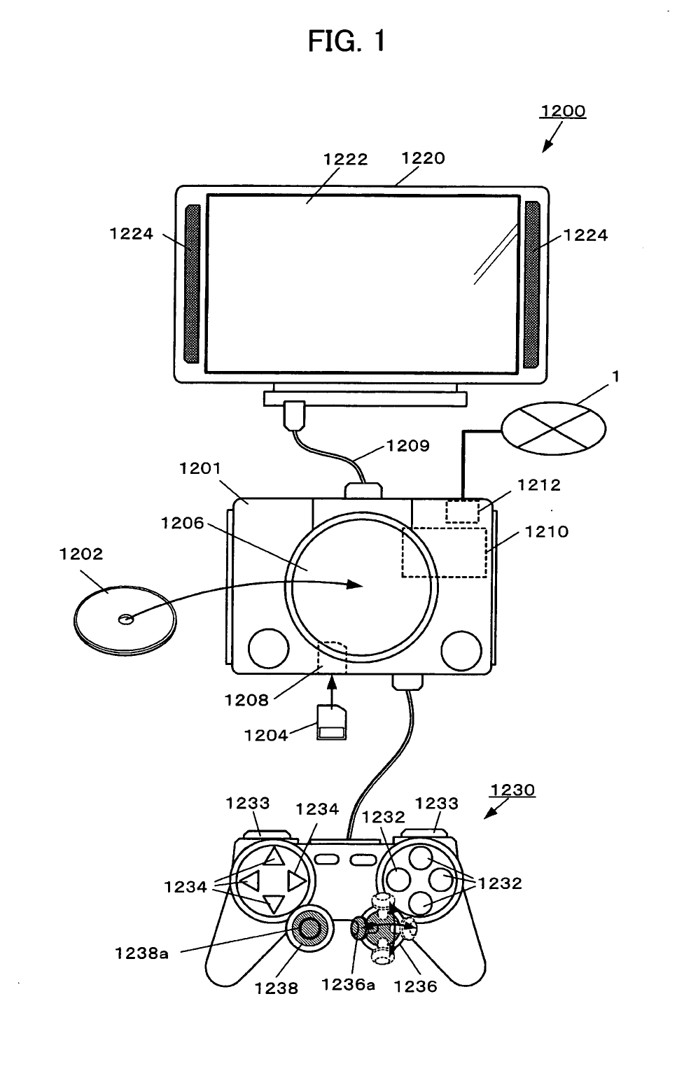

FIG. 1 is a system configuration diagram illustrative of a configuration example of a consumer game device according to this embodiment. A game device main body 1201 of a consumer game device 1200 includes a control unit 1210 provided with a CPU, an image processing LSI, an IC memory, and the like, and readers 1206 and 1208 for information storage media such as an optical disk 1202 and a memory card 1204. The consumer game device 1200 executes a given video game by reading a game program and various types of setting data from the optical disk 1202 and the memory card 1204 and performing various game calculations based on an operation input performed using a game controller.

A game image and game sound generated by the control unit 1210 of the consumer game device 1200 are output to a video monitor 1220 connected to the consumer game device 1200 via a signal cable 1209. A player enjoys the game by inputting various operations using the game controller 1230 while watching the game image displayed on a display 1222 of the video monitor 1220 and listening to the game sound such as background music (BGM) and effect sound output from a speaker 1224.

The game controller 1230 includes push buttons 1232 provided on the upper surface of the controller and used for selection, cancellation, timing input, and the like, push buttons 1233 provided on the side surface of the controller, arrow keys 1234 used to individually input an upward, downward, rightward, or leftward direction, a right analog lever 1236, and a left analog lever 1238.

The right analog lever 1236 and the left analog lever 1238 are direction input devices by which two axial directions (i.e., upward/downward direction and rightward/leftward direction) can be simultaneously input. A player normally holds the game controller 1230 with the right and left hands, and operates the game controller 1230 with the thumbs placed on levers 1236a and 1238a. An arbitrary direction including two axial components and an arbitrary amount of operation depending on the amount of tilt of the lever can be input by operating the levers 1236a and 1238a. Each analog lever can also be used as a push switch by pressing the lever in its axial direction from the neutral state in which an operation input is not performed. In this embodiment, the movement and expansion/contraction of a player character are input by operating the right analog lever 1236 and the left analog lever 1238.

The consumer game device 1200 may acquire a game program and setting data necessary for executing the game by connecting with a communication line 1 via a communication device 1212 and downloading the game program and setting data from an external device. The term “communication line” used herein means a communication channel through which data can be exchanged. Specifically, the term “communication line” includes a communication network such as a local area network (LAN) using a private line (private cable) for direct connection, Ethernet (registered trademark), and the like, a telecommunication network, a cable network, and the Internet. The communication method may be a cable communication method or a wireless communication method.

### Player Character

In the video game according to this embodiment, a player operates an expandable string-shaped character as a player character, and moves the player character from a starting point to a specific goal point. A topographical obstacle which hinders the player character and a character which attempts to reduce the strength of the player character are set in a game space. The player clears the game by causing the player character to safely reach the goal before the strength of the player character becomes “0”, and the game ends when the strength of the player character has become “0” before the player character reaches the goal.

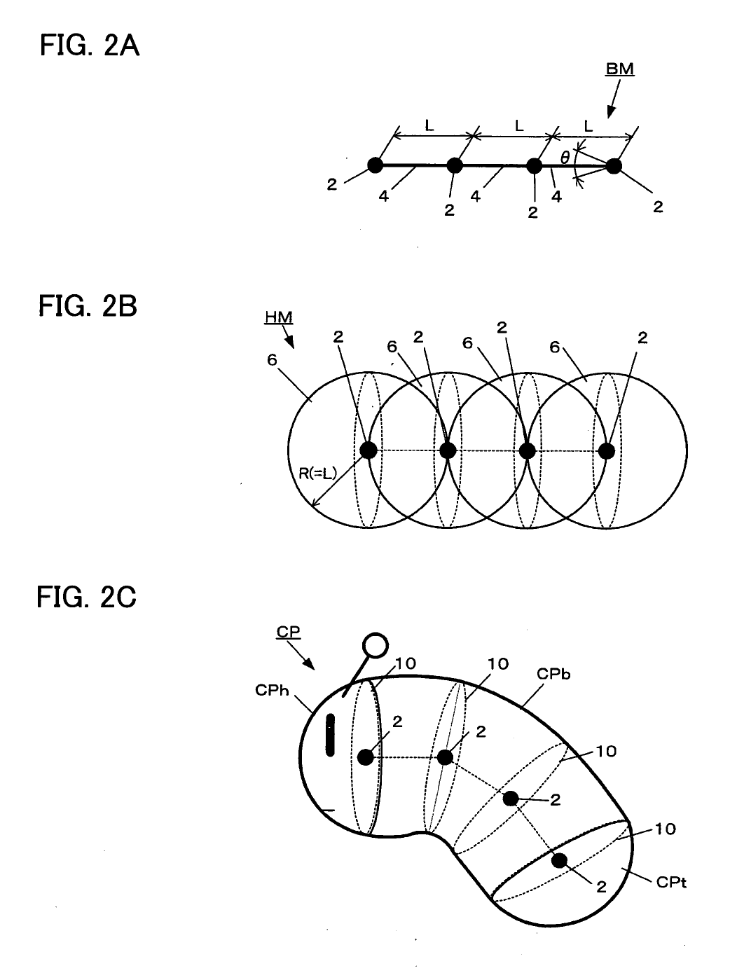

FIGS. 2A to 2C are views illustrative of the model configuration of the player character according to this embodiment. As shown in FIGS. 2A to 2C, a player character CP (leading character) operated by the player in the video game according to this embodiment is designed to be a worm (elongated animal without feet) having an imaginary string shape with one head and one tail. The player character CP is as flexible as a string and possesses an expandable trunk CPb such as that of a rheological object. Specifically, the player character CP is set to be a character which can expand/contract in forward/backward directions (directions toward a head CPh and a tail CPt) without changing the thickness of the trunk CPb. Although this embodiment illustrates an example in which the trunk CPb of the player character CP expands/contracts, the whole body of the player character CP including the head CPh and the tail CPt may expand/contract depending on the design of the character.

As shown in FIG. 2A, the player character CP has a skeleton model BM in which a plurality of nodes 2 are arranged at specific intervals L. In other words, the nodes 2 (i.e., control points) are connected via connectors 4 to form a joint structure. The connectors 4 have an identical fixed length L. The joint angle of the connector 4 with respect to the node 2 is limited within a specific angle range θ. Therefore, when the node 2 is considered to be a joint, the skeleton model BM is configured so that a plurality of joints are connected in series and the skeleton model BM can be bent at each joint by an angle equal to or less than a specific angle.

As shown in FIG. 2B, a hit determination model HM is set for the player character CP. In the hit determination model HM according to this embodiment, a hit determination area 6 is set corresponding to each node. The hit determination area 6 according to this embodiment is set to be a spherical area with a radius R (=length L of connector 4) around the position coordinates of the corresponding node 2.

As shown in FIG. 2C, the display model of the player character CP is formed using a polygon. Specifically, a display reference circle 10 containing the sum of vectors toward the adjacent nodes in a plane is set corresponding to each node 2. A head model and a tail model set in advance based on the head node and the end node of the skeleton model BM as reference points are disposed as the head CPh and the tail CPt. A plurality of polygons are generated, deformed, and relocated as the trunk CPb so that the outer circumferential edges defined by the display reference circles 10 set corresponding to the respective nodes are connected smoothly. The polygon model of the trunk CPb may be formed by appropriately utilizing known modeling technology such as a skeleton model skin formation process.

In this embodiment, since the radius of the display reference circle 10 is set to be the same as the radius R of the hit determination area 6, an object is determined to have hit the player character CP when the object has come into contact with the skin of the player character CP. Note that the invention is not limited thereto. The radius of the display reference circle 10 may set to be larger than the radius R of the hit determination area 6 to some extent so that a visual effect is achieved in which an object which has hit the player character CP sticks in the player character CP and the stuck portion of the object is hidden. In the following description, the node 2 in the front of the character may be referred to as “front node 2fr”, and the node 2 in the rear of the character may be referred to as “rear node 2rr”.

### Player Character Operation Method

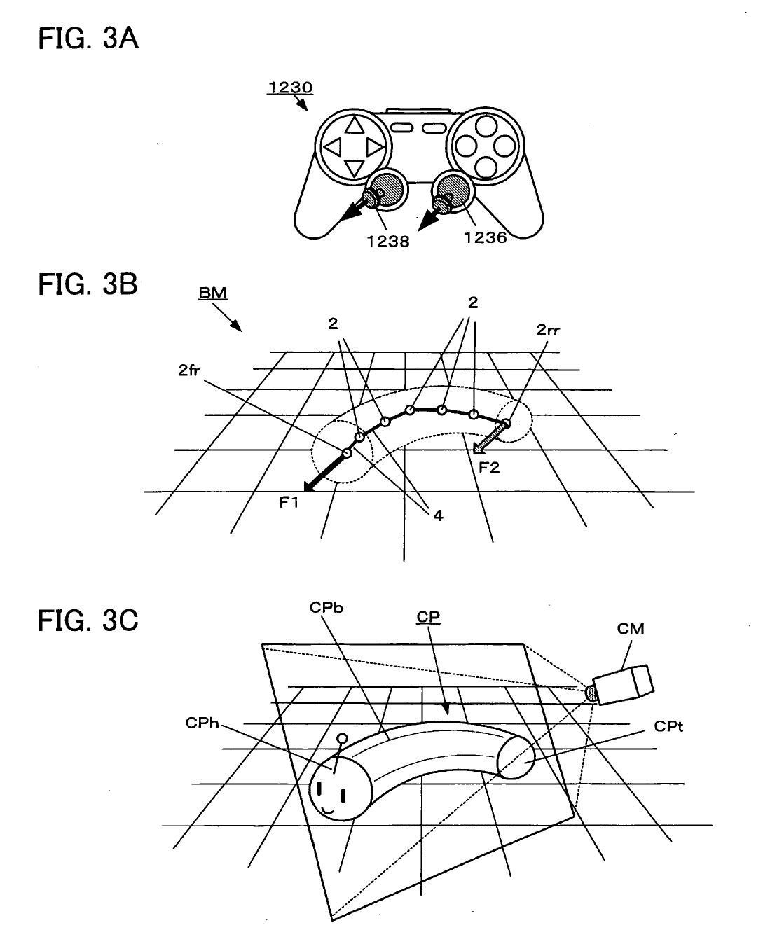

FIGS. 3A to 3C are schematic views showing the relationship between a movement operation and control of the player character CP according to this embodiment. As shown in FIGS. 3A to 3C, a first operation force F1 is set at the front node 2fr of the skeleton model BM based on an operation input performed using the left analog lever 1238 of the game controller 1230. A second operation force F2 is set at the rear node 2rr based on an operation input performed using the right analog lever 1236. Note that various forces which occur in the game space such as gravity and wind force and a force due to collision with another character may also be appropriately set. Description of such forces is omitted.

When the operation force F1 and the second operation force F2 have been set, the front end and the rear end of the skeleton model BM are pulled due to the operation force F1 and the second operation force F2, and the position of each node is updated according to a specific motion equation taking into account the above-described restraint conditions of the skeleton model BM. The position of the display model of the player character CP is updated by forming the skin based on the skeleton model BM of which the position of each node has been updated. A representation in which the player character CP moves in the game space is achieved by photographing the above state using a virtual camera CM and generating and displaying the photographed image on a game screen.

In this embodiment, the player can arbitrarily expand/contract the player character CP based on the first operation force F1 and the second operation force F2.

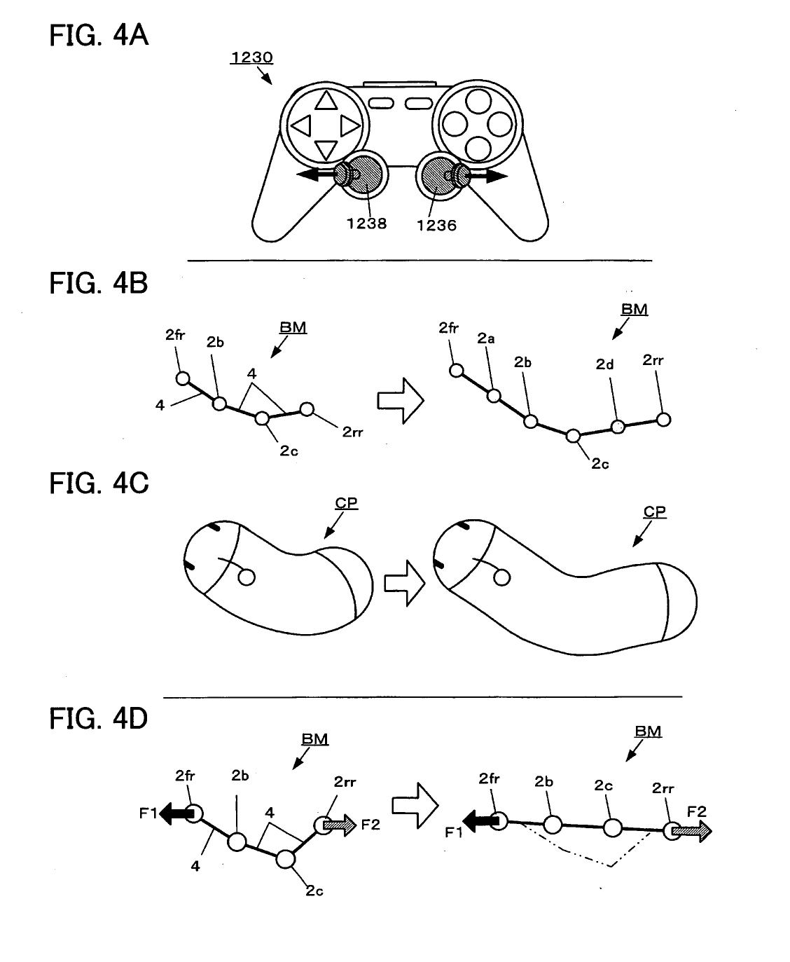

FIGS. 4A to 4D are schematic views showing the relationship between an arbitrary expansion operation and control of the player character CP according to this embodiment. As shown in FIG. 4A, an arbitrary expansion operation is input when the player simultaneously performs a right direction input and a left direction input respectively using the right analog lever 1236 and the left analog lever 1238 of the game controller 1230. This causes the skeleton model BM of the player character CP to change, as shown in FIG. 4B (overhead view) (i.e., from left to right). Specifically, a new node 2a is added between the front node 2fr and a node 2b adjacent to the front node 2fr, and a new node 2d is added between the rear node 2fr and a node 2c adjacent to the rear node 2fr. As shown in FIG. 4C (overhead view), a skin is formed on the display model of the player character CP based on the changed skeleton model BM so that the display model of the player character CP changes from a state in which the total length is small (left) to a state in which the total length increases (right).

On the other hand, when the player performs a right direction input and a left direction input respectively using the right analog lever 1236 and the left analog lever 1238, but it is determined that the right direction input and the left direction input are not simultaneously performed, the first operation force F1 based on the input using the left analog lever 1238 merely acts on the front node 2fr and the second operation force F2 based on the input using the right analog lever 1236 merely acts on the rear node 2rr. In FIG. 4D, the operation force F1 and the second operation force F2 act to pull the head CPh and the tail CPt of the player character CP, respectively, so that the front node 2fr and the rear node 2rr are pulled in opposite directions without a new node added. As a result, when the skeleton model BM has been curved, the skeleton model BM becomes almost linear, as shown on the right in FIG. 4D.

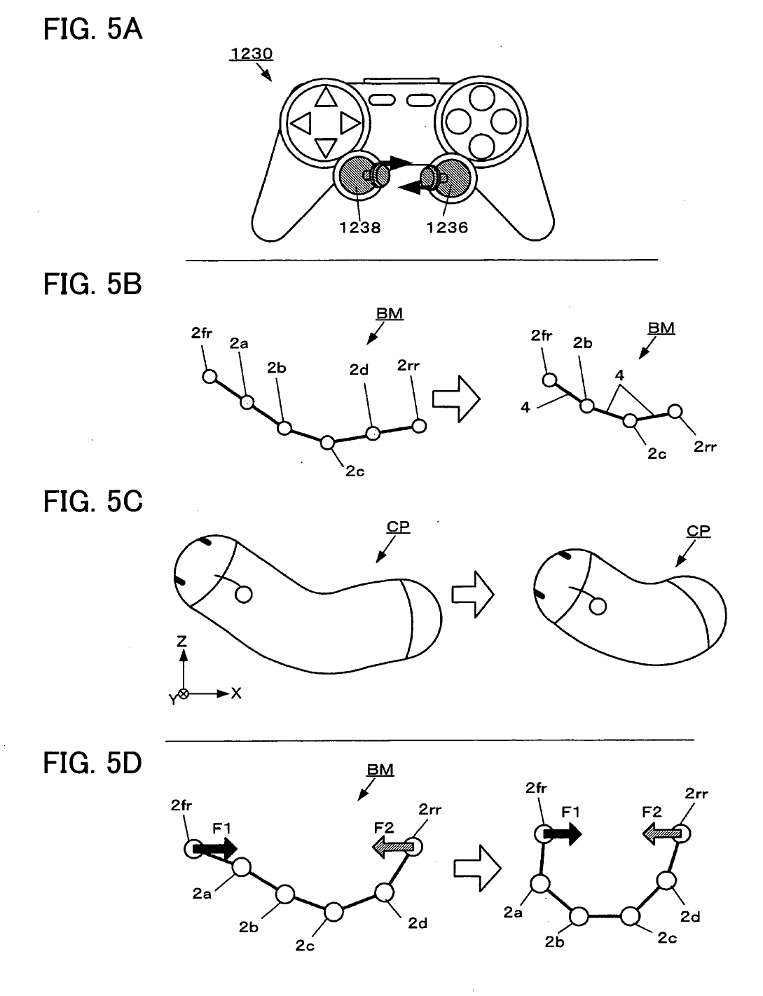

FIGS. 5A to 5D are schematic views showing the relationship between an arbitrary contraction operation and control of the player character CP according to this embodiment. As shown in FIG. 5A, an arbitrary contraction operation is input when the player simultaneously performs a left direction input and a right direction input respectively using the right analog lever 1236 and the left analog lever 1238 of the game controller 1230. When the arbitrary contraction operation has been input, the skeleton model BM of the player character CP changes from left to right in FIG. 5B (overhead view). Specifically, the node 2a adjacent to the front node 2fr and the node 2d adjacent to the rear node 2fr are removed. As shown in FIG. 5C (overhead view), a skin is formed on the display model of the player character CP based on the changed skeleton model BM so that the display model of the player character CP changes from a state on the left to a state in which the total length decreases (right).

On the other hand, when the player performs a left direction input and a right direction input respectively using the right analog lever 1236 and the left analog lever 1238, but it is determined that the left direction input and the right direction input are not simultaneously performed, the first operation force F1 based on the input using the left analog lever 1238 merely acts on the front node 2fr and the second operation force F2 based on the input using the right analog lever 1236 merely acts on the rear node 2rr. In FIG. 5D, the first operation force F1 and the second operation force F2 act to bring the head CPh and the tail CPt of the player character CP closer. As a result, when the skeleton model BM has been curved, the front node 2fr and the rear node 2rr become closer without the nodes removed (see right in FIG. 5D) so that the skeleton model BM is further curved, as shown on the right in FIG. 5D.

In this embodiment, the player character CP is operated in this manner. Therefore, it is desirable for the player that photographing conditions of the virtual camera CM are controlled so that the head CPh and the tail CPt of the player character CP are displayed on the game screen as much as possible and a situation around the player character CP can be observed to a certain extent. The term “photographing conditions” used herein include the position (i.e., relative position with respect to the player character CP (main photographing target)) in a world coordinate system, the view point direction, and the lens focal length setting (angle of view setting) of the virtual camera CM.

### Principle of Virtual Camera Photographing Condition Setting

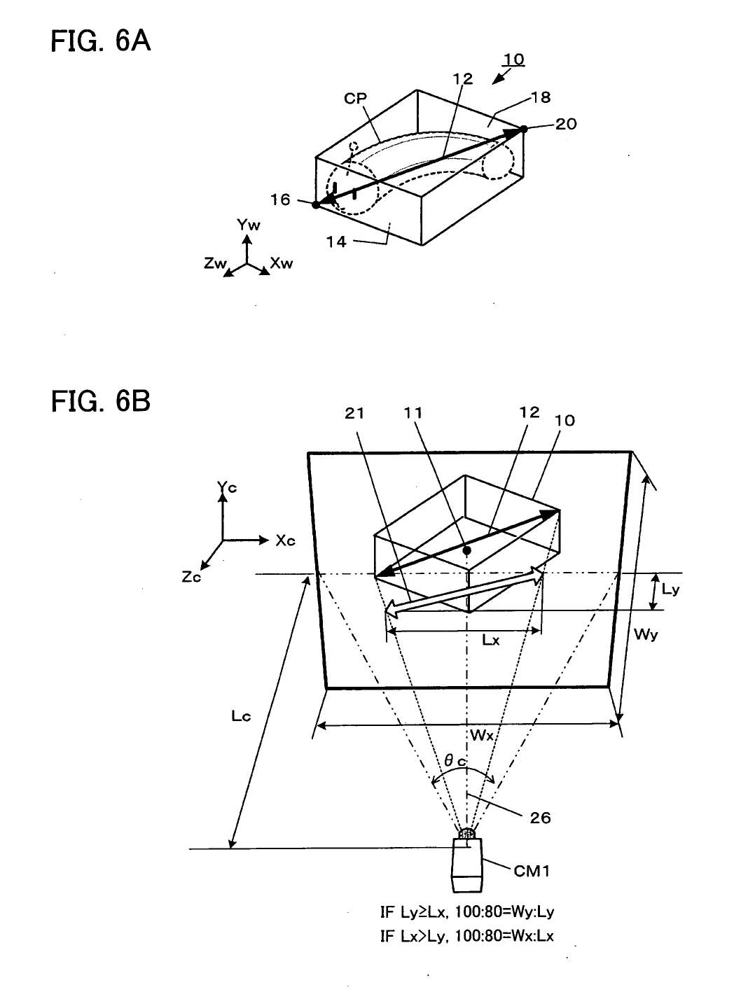

FIGS. 6A and 6B are schematic views illustrative of a method of setting the photographing conditions of the virtual camera according to this embodiment. In this embodiment, the photographing conditions of a virtual camera CM1 which mainly photographs the player character CP are set so that the entire inclusion area which includes the player character CP is basically included in an image photographed by the virtual camera.

As shown in FIG. 6A, an inclusion area 10 is set which includes the present player character CP. The inclusion area 10 is a rectangular parallelepiped formed by planes along an Xw axis, a Yw axis, and a Zw axis of the world coordinate system in the same manner as a boundary box.

When the inclusion area 10 has been set, the representative dimensions of the player character CP are determined for comparison with the height and the width of the game screen.

In this embodiment, the maximum diagonal line 12 is determined. The diagonal lines 12 are four line segments which connect vertices of a belly-side plane 14 (lower plane of the inclusion area 10 in the world coordinate system) parallel to the XwZw plane having a symmetrical relationship with respect to a center 11 of the inclusion area 10 with vertices of a back-side plane 18 (upper plane of the inclusion area 10 in the world coordinate system). In FIG. 6 A, a line segment which connects a vertex 16 of the belly-side plane 14 near the head with a vertex 20 of the back-side plane 18 near the tail is shown as the diagonal line 12.

The four diagonal lines determined are employed as candidates for basic dimensions for calculating the representative dimensions, and are projected onto the image coordinate system of the image photographed by the main virtual camera CM1, and an Xc axis component projection dimension Lx and a Yc axis component projection dimension Ly of a projected line segment 21 in the image coordinate system are calculated. The maximum value of the Xc axis component projection dimension Lx and the maximum value of the Yc axis component projection dimension Ly are respectively determined. These maximum values are used as the representative dimensions of the player character CP in the respective axial directions for comparison with the height and the width of the game screen.

After the representative dimensions have been determined, the representative dimensions are compared to select a larger projection dimension Lm (Xc axis component projection dimension Lx in FIG. 6 B), and the photographing conditions of the main virtual camera CM1 are determined so that the selected projection dimension Lm has a specific ratio (80%) with respect to a screen width Wx (i.e., height of the image photographed by the main virtual camera CM1) and a screen width Wy (i.e., width of the image photographed by the main virtual camera CM1) in the image coordinate axial directions.

For example, when the angle of view θc is made constant, an optimum photographing distance Lc of the virtual camera CM from the center 11 is geometrically calculated using the following equation in a state in which a line-of-sight direction 26 of the virtual camera CM faces the center 11 of the inclusion area 10.

Optimum photographing distance Lc={(100/80)×Lm)}/{2×tan(θc/2)} (1)

Note that the angle of view θc may be calculated in a state in which the optimum photographing distance Lc is made constant. In this case, the angle of view θc can be geometrically calculated. The optimum photographing distance Lc and the angle of view θc may also be calculated. For example, when it is desired to move the main virtual camera CM1 to turn round the player character CP from the viewpoint of game production, data which defines the camera work is defined in advance, and the angle of view θc is calculated after determining the position of the main virtual camera CM1 based on the data. Specifically, the optimum photographing distance Lc is determined, and the angle of view θc may be calculated based on the determined optimum photographing distance Lc.

Whether to dispose the main virtual camera CM1 on the right or left with respect to the player character CP may be appropriately determined. In this embodiment, since the movement of the head CPh is controlled based on an operation input using the left analog lever 1238 and the movement of the tail CPt is controlled based on an operation input using the right analog lever 1236, it is desirable to dispose the virtual camera CM on the left with respect to the player character CP to photograph the left side of the player character CP, for example. Specifically, since the head CPb of the player character CP is displayed on the left of the game screen and the tail CPt of the player character CP is displayed on the right of the screen, the arrangement relationship of the input means of the game controller 1230 coincides with the right/left positional relationship so that a comfortable operation feel is obtained.

Therefore, the head CPh and the tail CPt of the player character CP which are used as references when the player operates the player character CP are always photographed by the main virtual camera CM1, and a situation around the player character CP is also photographed to a certain extent. In this case, the process of calculating the representative dimension is also very simple.

### Sub Screen Display

In this embodiment, even if the photographing conditions of the main virtual camera CM1 are appropriately set, the entire player character CP is not necessarily photographed since an obstacle exists between the player character CP (object) and the main virtual camera CM1 (e.g., the player character CP is hidden behind a building). Therefore, a sub-virtual camera which photographs the player character CP is separately provided, and an image photographed by the sub-virtual camera is separately displayed on a sub-screen.

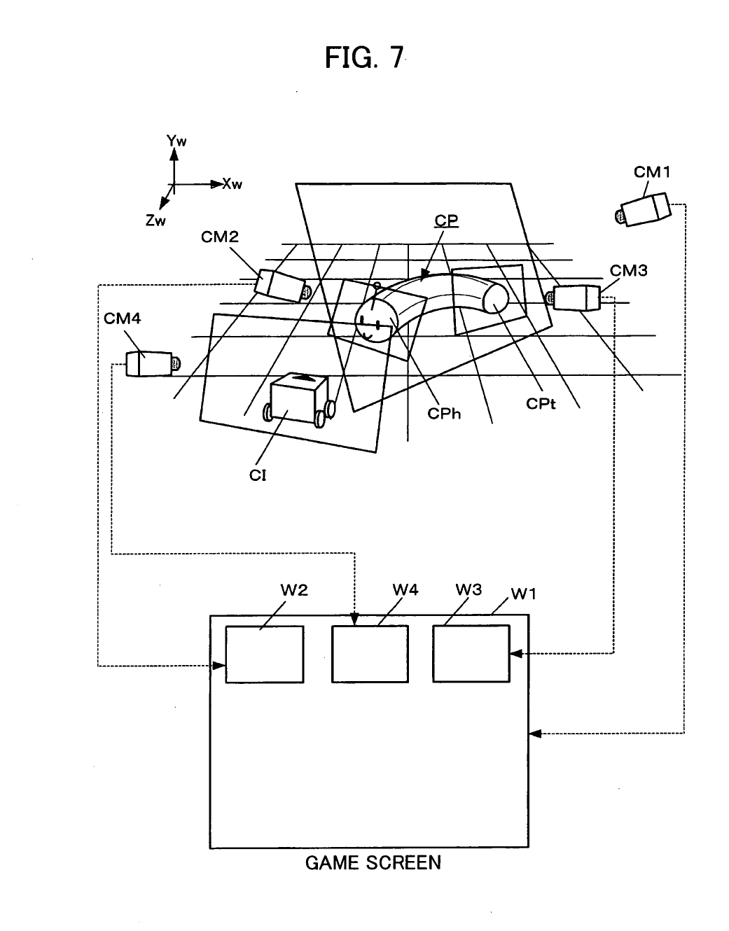

FIG. 7 is a schematic view illustrative of a sub-virtual camera setting and a sub-screen display according to this embodiment. In FIG. 7, the upper portion indicates the game space, and the lower portion indicates the game screen. In this embodiment, a first sub-virtual camera CM2 which photographs the head CPh and a second sub-virtual camera CM3 which photographs the tail CPb are set in addition to the main virtual camera CM1 which photographs the entire player character CP, as shown in FIG. 7. As shown in the lower portion in FIG. 7, the images photographed by the first sub-virtual camera CM2 and the second sub-virtual camera CM3 are displayed on a main game screen W1 based on the image photographed by the main virtual camera CM1 as sub-screens W2 and W3 smaller than the main game screen W1.

Therefore, even if another object exists between the main virtual camera CM1 and the player character CP as an obstacle so that the head CPh and the tail CPt of the player character CP are not temporarily observed, these portions can be observed from the sub-screens W2 and W3. This makes it possible the player to fully observe the player character CP (i.e., each end of the player character CP which is the direct operation target). This increases operability to prevent a situation in which the head CPh is not displayed on the game screen when the player desires to move the head CPh to hinder the game operation. In this embodiment, the sub-virtual camera is also set upon occurrence (issuance) of an event. The term “event” used herein refers to a series of control such as a situation in which a special object appears depending on the progress of the game or an object which has been disposed in the game space starts a specific operation at a specific timing. For example, the term “event” used herein refers to a case where an enemy character appears or a case where a tree falls to form a bridge across a river. When such an event has occurred which satisfies an event occurrence condition, an event virtual camera CM4 is set as one type of sub-virtual camera which photographs a character which appears along with the event or an automatically controlled character, and the photographed image is displayed on the main game screen W1 as a pop-up sub-screen W4.

In this embodiment, the photographing conditions of the event virtual camera CM4 are set so that an object character is photographed and part of the player character CP is photographed within the angle of view. Therefore, the sub-screen W4 is additionally displayed when an event has occurred so that the player can immediately identify the situation and the position thereof in the game space.

In a game in which the player operates a string-shaped character to move each end of the character in the same manner as in this embodiment, it is necessary to display the player character CP on the game screen to have a certain size in order to maintain an operation feel and operability. This reduces the area in which a situation around the player character CP is displayed, whereby operability may decrease due to difficulty in observing the situation around the player character CP. It is possible to eliminate such a disadvantage by setting the event virtual camera CM4 and displaying the image photographed by the event virtual camera CM4 on a sub-screen.

### Functional Blocks

A functional configuration which implements the above features is described below.

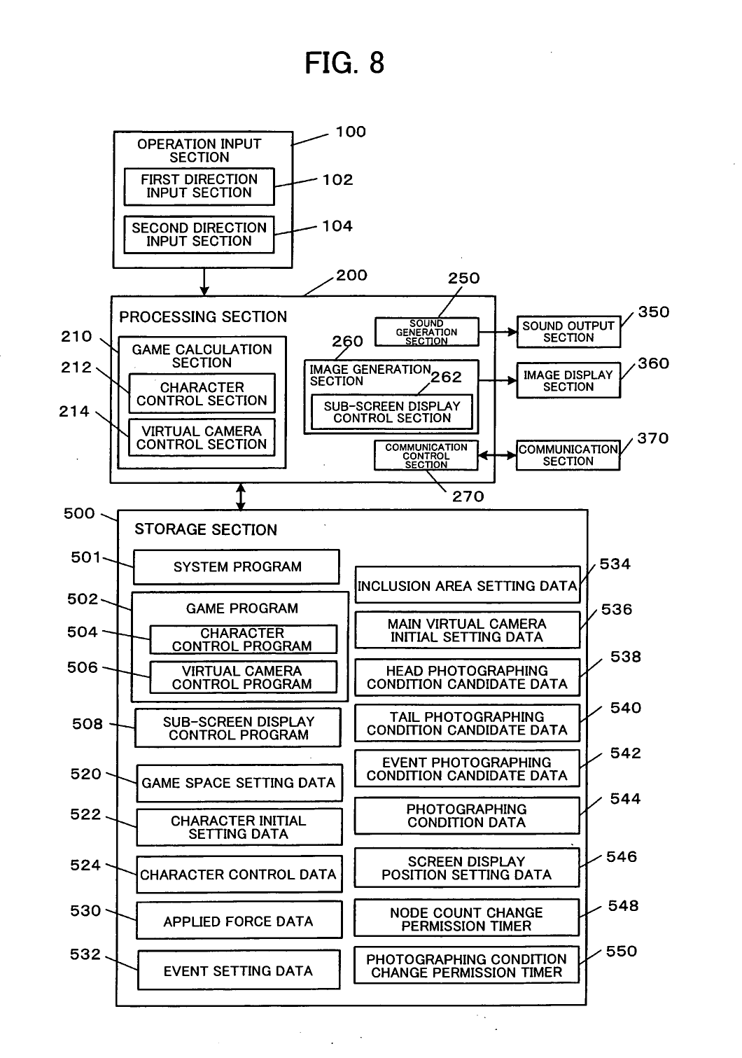

FIG. 8 is a functional block diagram showing an example of a functional configuration according to this embodiment. As shown in FIG. 8, the game device according to this embodiment includes an operation input section 100, a processing section 200, a sound output section 350, an image display section 360, a communication section 370, and a storage section 500.

The operation input section 100 outputs an operation input signal to the processing section 200 based on an operation input performed by the player. In FIG. 1, the game controller 1230 corresponds to the operation input section 100. The operation input section 100 according to this embodiment includes a first direction input section 102 and a second direction input section 104 by which at least two axial directions can be input by one input operation.

The first direction input section 102 and the second direction input section 104 may be implemented by an analog lever, a trackpad, a mouse, a trackball, a touch panel, or the like. The first direction input section 102 and the second direction input section 104 may also be implemented by a multi-axis detection acceleration sensor having at least two detection axes, a plurality of single-axis detection acceleration sensors, a multi-direction tilt sensor which enables at least two detection directions, a plurality of single-direction tilt sensors, or the like. The right analog lever 1236 and the left analog lever 1238 shown in FIG. 1 correspond to the first direction input section 102 and the second direction input section 104 according to this embodiment. The first direction input section 102 and the second direction input section 104 are respectively used to input the directions and the amounts of movement of the head CPh and the tail CPt of the player character CP.

The processing section 200 is implemented by electronic parts such as a microprocessor, an application specific integrated circuit (ASIC), and an IC memory. The processing section 200 inputs and outputs data to and from each functional section of the game device 1200 including the operation input section 100 and the storage section 500, and controls the operation of the game device 1200 by performing various calculations based on a specific program, data, and an operation input signal from the operation input section 100. In FIG. 1, the control unit 1210 included in the game device main body 1201 corresponds to the processing section 200.

The processing section 200 according to this embodiment includes a game calculation section 210, a sound generation section 250, an image generation section 260, and a communication control section 270.

The game calculation section 216 performs a game process. For example, the game calculation section 210 performs a process of forming a game space in a virtual space, a process of controlling the movement of a character other than the player character CP disposed in the virtual space, a hit determination process, a physical calculation process, a game result calculation process, a skin formation process, and the like. The game calculation section 210 according to this embodiment includes a character control section 212 and a virtual camera control section 214.

The character control section 212 changes the size and/or the shape of the object of the player character CP to control the operation of the player character CP. For example, the character control section 212 expands/contracts and moves the player character CP. The character control section 212 also controls the operation of a non-player character (NPC) other than the player character.

The virtual camera control section 214 controls the virtual camera. In this embodiment, the virtual camera control section 214 sets the photographing conditions of the main virtual camera CM1, the sub-virtual cameras CM2 and CM3, and the event virtual camera CM4, disposes or removes the virtual camera, and controls the movement of the virtual camera.

The sound generation section 250 is implemented by a processor such as a digital signal processor (DSP) and its control program. The sound generation section 250 generates sound signals of game-related effect sound, BGM, and operation sound based on the processing results of the game calculation section 210, and outputs the generated sound signals to the sound output section 350.

The sound output section 350 is implemented by a device which outputs sound such as effect sound and BGM based on the sound signal input from the sound generation section 250. In FIG. 1, the speaker 1224 of the video monitor 1220 corresponds to the sound output section 500.

The image generation section 260 is implemented by a processor such as a digital signal processor (DSP), its control program, a drawing frame IC memory such as a frame buffer, and the like. The image generation section 260 generates one game image in frame ( 1/60 sec) units based on the processing results of the game calculation section 210, and outputs image signals of the generated game image to the image display section 360.

In this embodiment, the image generation section 260 includes a sub-screen display control section 262.

The sub-screen display control section 262 displays an image photographed by the main virtual camera CM1, an image photographed by the sub-virtual camera CM2, an image photographed by the sub-virtual camera CM3, or an image photographed by the event virtual camera CM4 as the main game screen W1, and displays the remaining images on the main game screen as the sub-screens W2 to W4. The sub-screen display control section 262 changes images displayed on the main game screen W1 and the sub-screens depending on the player's sub-screen selection/switching operation.

The image display section 360 displays various game images based on the image signals input from the image generation section 260. The image display section 360 may be implemented by an image display device such as a flat panel display, a cathode-ray tube (CRT), a projector, or a head mount display. In FIG. 1, the display 1222 of the video monitor 1220 corresponds to the image display section 360.

The communication control section 270 performs data processing relating to data communications to exchange data with an external device via the communication section 370.

The communication section 370 connects with a communication line 2 to implement data communications. For example, the communication section 370 is implemented by a transceiver, a modem, a terminal adapter (TA), a jack for a communication cable, a control circuit, and the like. In FIG. 1, the communication device 1212 and a short-distance wireless communication module 1214 correspond to the communication section 370.

The storage section 500 stores a system program which implements a function of causing the processing section 200 to control the game device 1200, a game program and data necessary for causing the processing section 200 to execute the game, and the like. The storage section 500 is used as a work area for the processing section 200, and temporarily stores the results of calculations performed by the processing section 200 based on various programs, data input from the operation section 100, and the like. The function of the storage section 500 is implemented by an IC memory (e.g., RAM or ROM), a magnetic disk (e.g., hard disk), an optical disk (e.g., CD-ROM or DVD), or the like.

In this embodiment, the storage section 500 stores a system program 501, a game program 502, and a sub-screen display control program 508. The game program 502 further includes a character control program 504 and a virtual camera control program 506.

The function of the game calculation section 210 may be implemented by the processing section 200 by causing the processing section 200 to read and execute the game program 502. The function of the sub-screen display control section 262 may be implemented by the image generation section 260 by causing the processing section 200 to read and execute the sub-screen display control program 508.

The storage section 500 stores game space setting data 520, character initial setting data 522, event setting data 532, main virtual camera initial setting data 536, head photographing condition candidate data 538, tail photographing condition candidate data 540, and event photographing condition candidate data 542 as data provided in advance.

The storage section 500 also stores character control data 524, applied force data 530, inclusion area setting data 534, photographing condition data 544, and screen display position setting data 546 as data appropriately rewritten during the progress of the game. The storage section 500 also stores a timer value which is appropriately required when performing the game process, for example. In this embodiment, the storage section 500 temporarily stores count values of various timers including a node count change permission timer 548 and a photographing condition change permission timer 550.

Various types of data used to form a game space in a virtual space are stored as the game space setting data 520. For example, the game space setting data 520 includes motion data as well as model data and texture data relating to objects including the earth's surface on which the player character CP moves and buildings.

Initial setting data relating to the player character CP is stored as the character initial setting data 522. In this embodiment, the player character CP has the trunk CPb with a specific length when starting the game. Specifically, data relating to the skeleton model BM in which a specific number of nodes 2 are arranged and the hit determination model HM of the skeleton model BM is stored as the character initial setting data 522. Model data relating to the head CPh and the tail CPt of the player character CP, texture data used when forming a skin on the trunk CPb, and the like are also stored as the character initial setting data 522.

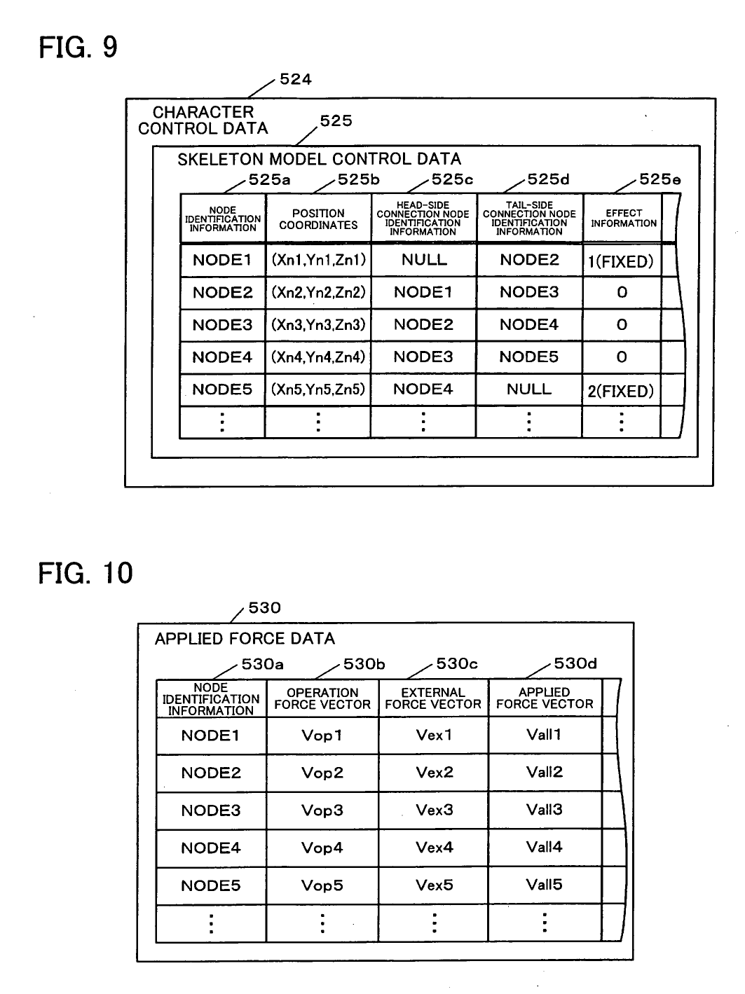

Data used to control the player character CP during the game is stored as the character control data 524. FIG. 9 is a view showing a data configuration example of the character control data 524 according to this embodiment. As shown in FIG. 9, the character control data 524 includes control data 525 which is data relating to the skeleton model of the player character CP.

As the skeleton model control data 525, position coordinates 525b of the node in the game space coordinate system, head-side connection node identification information 525c, tail-side connection node identification information 525d, and effect information 525e are stored while being associated with node identification information 525a.

The identification information relating to nodes (head-side node is forward and tail-side node is backward) connected to that node in the arrangement order is set as the head-side connection node identification information 525c and the tail-side connection node identification information 525d. Specifically, the head-side connection node identification information 525c defines the head-side (forward) node connected to that node, and the tail-side connection node identification information 525d defines the tail-side (backward) node connected to that node. Since the front node 2fr and the rear node 2rr are end nodes, data “NULL” is stored as shown in FIG. 9, for example.

The effect information 525e indicates whether or not the node is subjected to a virtual force (operation force) based on an operation input using the right analog lever 1236 or the left analog lever 1238. As shown in FIG. 9, data “2” is stored corresponding to the node which is subjected to a virtual force based on an operation input using the right analog lever 1236, data “1” is stored corresponding to the node which is subjected to a virtual force based on an operation input using the left analog lever 1238, and data “0” is stored corresponding to the remaining nodes.

In this embodiment, a new node is registered in the skeleton model control data 525 when expanding the player character CP, and the registered node is deleted when contracting the player character CP. The skeleton model BM expands or contracts upon addition or deletion of the node.

Information relating to the force applied to each node is stored as the applied force data 530.

FIG. 10 is a view showing a data configuration example of the applied force data 530 according to this embodiment. As shown in FIG. 10, an operation force vector 530b, an external force vector 530c, and an applied force vector 530d (resultant force of these forces) are stored while being associated with node identification information 530a, for example. Other forces may also be appropriately set which affect movement control of the player character CP during the game.

The vector of the virtual force (i.e., operation force) which is set based on an operation input using the right analog lever 1236 or the left analog lever 1238 and is applied to the node set in the effect information 525e and each node depending on the connection structure of the skeleton model BM is stored as the operation force vector 530b. Specifically, since the operation force based on an operation input using the right analog lever 1236 is directly applied to the node for which data “2” is stored as the effect information 525e, the operation force is directly stored as the operation force vector 530b.

The operation force is not directly applied to the nodes which form the trunk. However, since these node are sequentially connected with the end nodes, the force applied via the connectors 4 is stored as the operation force vector 530b. Therefore, when the skeleton model BM is straight and the operation force is applied in the extension direction (expansion direction), the same operation force as the operation force applied to the end node is stored as the operation force vector 530b of each node. On the other hand, when the skeleton model BM is curved, the force of the connector direction component of the operation force applied to the end node is stored as the operation force vector 530b depending on the node connection relationship.

A field of force set in the game space and a virtual force which is applied due to the effects of other objects disposed in the game space are stored as the external force vector 530c. For example, gravity, a force which occurs due to collision or contact with another object, a force which occurs due to environmental wind, and the like are included in the external force vector 530c. An electromagnetic force, a virtual force which indicates a state in which the player character CP is drawn toward a favorite food, and the like may also be appropriately included in the external force vector 530c.

Data necessary for generating an event is stored as the event setting data 532. For example, the event setting data 532 includes a condition whereby an event is generated, data and motion data relating to an object which appears or is operated when an event is generated, a finish condition whereby an event is determined to have finished, and the like.

Data which defines the inclusion area 10 required to determine the photographing conditions of the main virtual camera CM1 is stored as the inclusion area setting data 534. For example, the coordinates of each vertex of the inclusion area 10, the coordinates of the center 11 of the inclusion area 10, and information relating to the diagonal line 12 are stored as the inclusion area setting data 534.

An initial setting of the photographing conditions of the main virtual camera CM1 is stored as the main virtual camera initial setting data 536. Specifically, the relative position coordinates with respect to the player character CP used to calculate the temporary position, the line-of-sight direction vector, and the initial angle of view (may be the lens focal length) used when determining the photographing conditions of the main virtual camera CM1 are defined as the main virtual camera initial setting data 536.

Options for the photographing conditions when photographing specific portions of the player character CP using the sub-virtual cameras are stored as the head photographing condition candidate data 538 and the tail photographing condition candidate data 540. The head photographing condition candidate data 538 is applied to the first sub-virtual camera CM2 which photographs the head CPh, and the tail photographing condition candidate data 540 is applied to the second sub-virtual camera CM3 which photographs the tail CPt. The candidates for the photographing conditions stored as the head photographing condition candidate data 538 and the tail photographing condition candidate data 540 are appropriately set from the viewpoint of operability and production of the game depending on the photographing target portion.

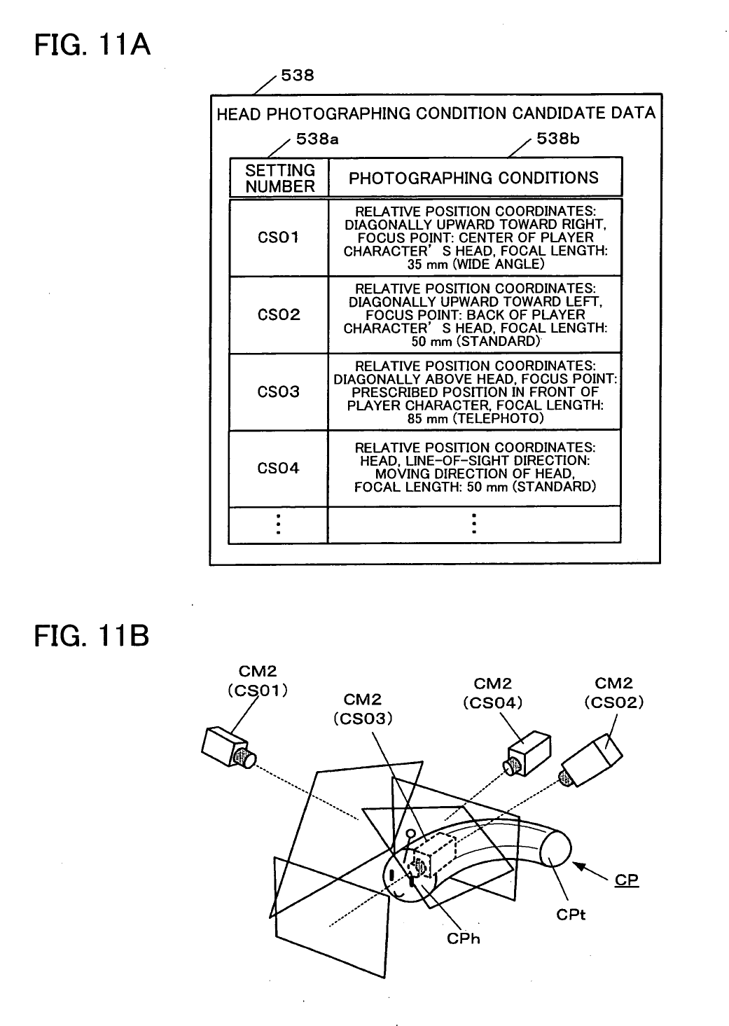

FIG. 11A is a view showing a data configuration example of the head photographing condition candidate data 538 according to this embodiment, and FIG. 11B is a view showing an outline of the photographing conditions in the example shown in FIG. 11A. As shown in FIG. 11A, photographing conditions 538b adaptively determined from the viewpoint of the operability and production of the game are stored as the head photographing condition candidate data 538 while being associated with a setting number 538a. The photographing conditions 538b include the relative position coordinates with respect to the representative point of the player character CP, a focus point in the line-of-sight direction, and a lens focal length used to determine the angle of view, for example.

In this embodiment, the photographing conditions 538b include photographing conditions (setting number 538a: CS01 and CS02) set so that the head CPh and a portion around the head CPh are accommodated within a specific photographing range in the photographed image, photographing conditions (setting number 538a: CS03 and CS04) set so that the line-of-sight direction is directed from the position behind the head CPh or the position of the head CPt along the moving direction of the head CPh, photographing conditions set to photograph the front of the head CPh and a portion around the head CPh, and the like. Note that other photographing conditions which allow the player to observe the situation around the head CPh when moving the head CPh may be appropriately set (e.g., photographing conditions set so that the head CPh and a portion around the head CPh are accommodated within a specific photographing range in the photographed image from diagonally forward of the head CPh).

The tail photographing condition candidate data 540 is basically similar to the head photographing condition candidate data 538 as to the photographing conditions setting except for the photographing target portion. The tail photographing condition candidate data 540 has a data configuration similar to that of the head photographing condition candidate data 538. When photographing a portion other than the head CPh and the tail CPt, photographing condition candidate data corresponding to that portion is appropriately added.

Options for the photographing conditions when photographing an event character CI using the event virtual camera CM4 are stored as the event photographing condition candidate data 542.

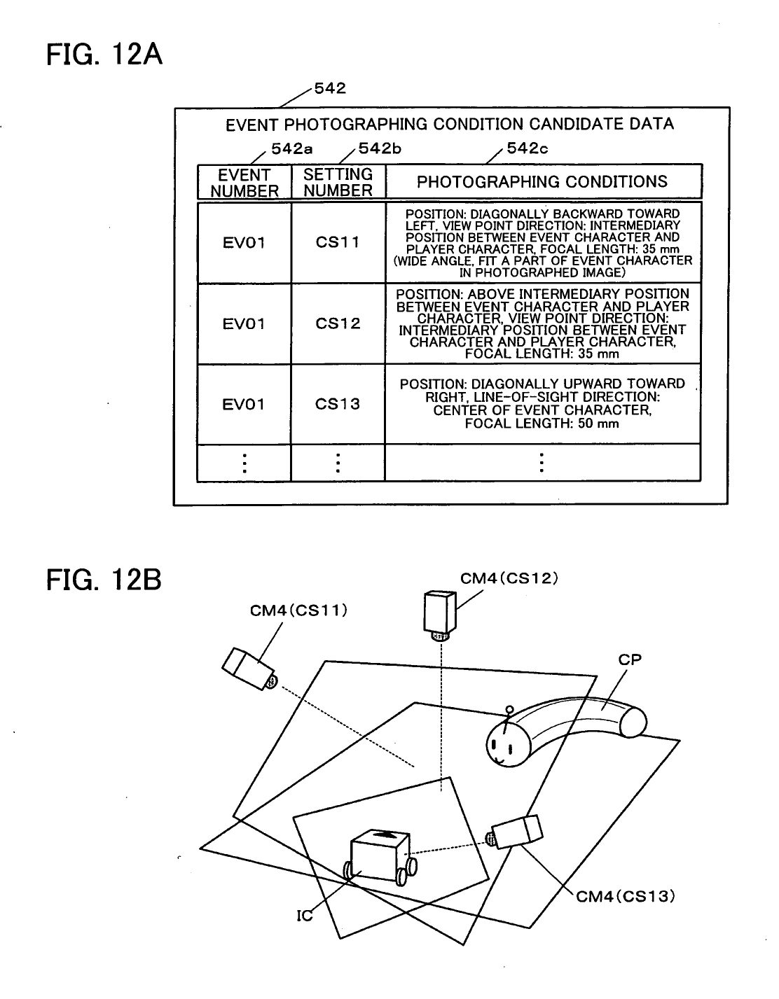

FIG. 12A is a view showing a data configuration example of the event photographing condition candidate data 542 according to this embodiment, and FIG. 12B is a view showing an outline of FIG. 12A. As shown in FIG. 12A, a setting number 542b and photographing conditions 542c are stored as the event photographing condition candidate data 542 while being associated with an event number 542a of the event defined by the event setting data 532. The photographing conditions 542c include the relative position coordinates which indicate the position of the event virtual camera CM4. with respect to the representative point of the event character CI, the line-of-sight direction (or focus point), and a lens focal length used to determine the angle of view, for example. In this embodiment, the photographing conditions 542c include photographing conditions (setting number 542b: CS11 and CS12) set so that at least part of the event character CI and part of the player character CP appear in the image photographed by the event virtual camera CM4, and photographing conditions (setting number 542b: CS13) set to photograph the event character CI and a portion around the event character CI.

The photographing conditions are set so that the event character and the player character appear in the image photographed by the event virtual camera CM4 in order to allow the player to observe the relative positional relationship between the event character and the player character. This allows the player to easily determine the operation of the player character CP. When it is advantageous that the relative position of the event character is not observed by the player in view of production depending on the game, only the photographing conditions set so that the event character IC is positioned within the angle of view but the player character CP is not positioned within the angle of view may be employed.

Information relating to control of the virtual camera including the current photographing conditions of the virtual camera during the game is stored as the photographing condition data 544. For example, the photographing condition data 544 includes the current position coordinates of the virtual camera in the world coordinate system and the line-of-sight direction and the angle of view θc of the virtual camera.

Information relating to the display positions and the display state of the main game screen and each sub-screen is stored as the image display position setting data 546.

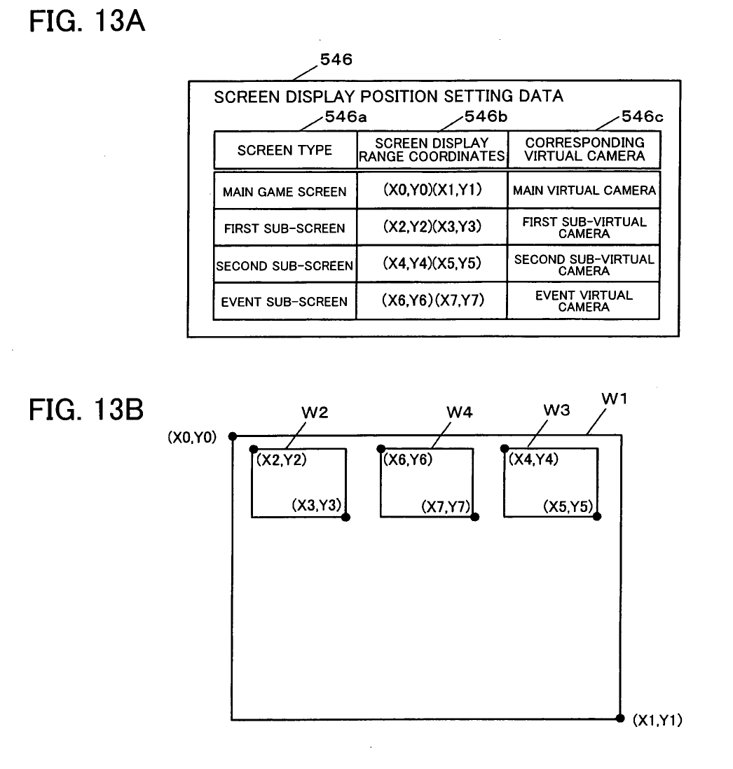

FIG. 13A is a view showing a data configuration example of the image display position setting data 546 according to this embodiment, and FIG. 13B is a view showing an outline of the data configuration shown in FIG. 13A. As shown in FIG. 13A, screen display range coordinates 546b and a corresponding virtual camera 546c which defines the virtual camera which is the source of the image displayed on the screen are stored as the image display position setting data 546 while being associated with a screen type 546a (i.e., main game screen, first sub-screen, second sub-screen, and event sub-screen). In this embodiment, an image displayed on the main game screen and an image displayed on the sub-screen are changed depending on the player's sub-screen selection/switching operation. In this case, the definition of the corresponding virtual camera 546c corresponding to the screen type 546a is changed.

The size of the main game screen W1 corresponds to the size of the image display range of the display 1222 (i.e., displays an image over the entire screen). In the example shown in FIGS. 13A and 13B, two sub-virtual cameras and one event virtual camera are registered. Note that the number of sub-virtual cameras and the number of event virtual cameras may be appropriately set depending on the game, the design of the player character, and the like. The display positions and the display state of the sub-screens W2 to W4 are not limited to the example shown in FIG. 13B. For example, the sub-screens W2 to W4 may be displayed in parallel with the main game screen W1 (displayed as in the shape of tiles (note that the main game screen is larger than the sub-screen).

The count value of a timer which measures the time is stored as the node count change permission timer 548. In this embodiment, the timer measures the time when the expansion/contraction control of the player character CP is not performed. The expansion/contraction control of the player character CP is limited (is not performed) when the measured time (i.e., count value) has not reached a specific standard.

A time interval which is decremented from a specific value and in which the photographing conditions can be permitted is stored as the photographing condition change permission timer 550. In this embodiment, the photographing conditions can be changed each time the time measures a reference time. The initial value of the photographing condition change permission timer 550 when starting the game is “0”.

### Operation

An operation according to the invention is described below.

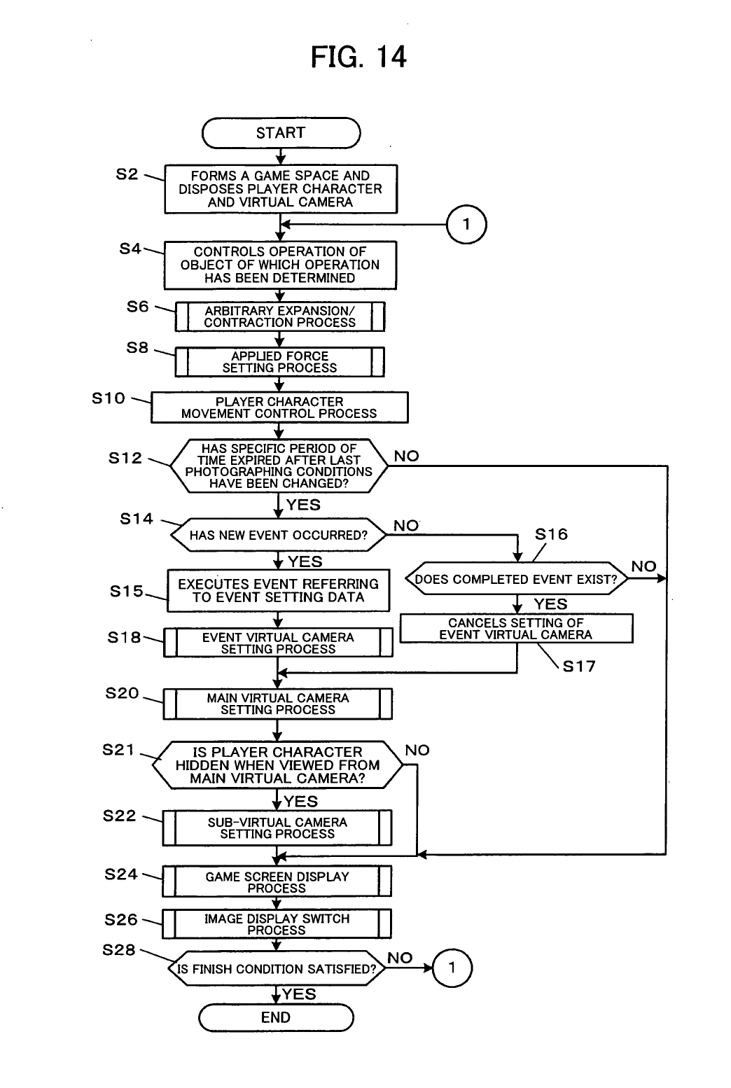

FIG. 14 is a flowchart illustrative of the flow of a process according to this embodiment. The following process is implemented by causing the processing section 200 to read and execute the system program 501, the game program 502, and the sub-screen display control program 508.

As shown in FIG. 14, the game calculation section 210 forms a game space in a virtual space and disposes the player character CP and the main virtual camera CM1 which photographs the player character CP in the resulting game space referring to the game space setting data 520, the character initial setting data 522, and the main virtual camera initial setting data 536 (step S2).

The initial skeleton model BM is registered as the skeleton model control data 525 of the character control data 524 when the player character CP has been disposed, and a skin is formed based on the registered skeleton model BM to dispose the display model of the player character CP in the game space. The skin may be formed on the skeleton model BM appropriately utilizing known technology. Therefore, detailed description is omitted. The initial photographing conditions of the main virtual camera CM1 are stored as the photographing condition data 544. When an NPC is disposed in the game space when starting the game, the NPC is disposed in this stage.

When the game has been started, the game calculation section 210 controls the operation of an object (e.g., NPC) of which the operation has been determined in advance (step S4). For example, when setting trees which bend before the wind, an airship, a toy car which hinders the movement of the player character CP, and the like, the movement of each object is controlled based on specific motion data.

The game calculation section 210 performs an arbitrary expansion/contraction process which expands or contracts the player character CP based on an operation input of the player (step S6).

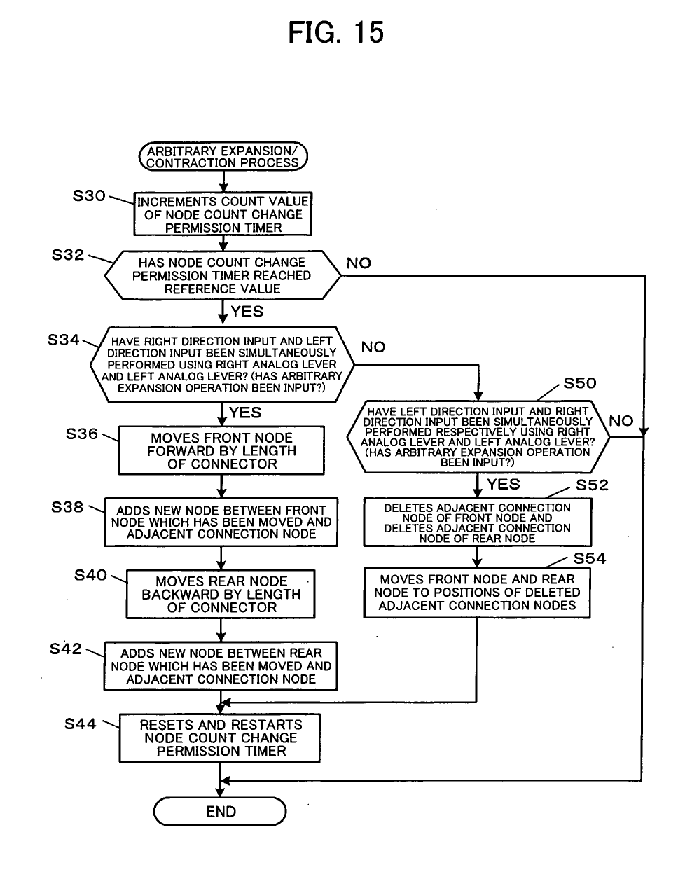

FIG. 15 is a flowchart illustrative of the flow of the arbitrary expansion/contraction process according to this embodiment. As shown in FIG. 15, the game calculation section 210 increments the count value of the node count change permission timer 548 by a specific number (step S30), and determines whether or not the incremented count value of the node count change permission timer 548 has reached a reference value (step S32).

When the game calculation section 210 has determined that the count value of the node count change permission timer 548 has not reached a reference value (NO in step S32), the game calculation section 210 finishes the arbitrary expansion/contraction process.

When the game calculation section 210 has determined that the count value of the node count change permission timer 548 has reached a reference value (YES in step S32), the game calculation section 210 determines whether or not a specific arbitrary expansion operation has been input (step S34). Specifically, the game calculation section 210 determines whether or not the player has simultaneously performed a right direction input and a left direction input respectively using the right analog lever 1236 and the left analog lever 1238. Specifically, the game calculation section 210 determines whether or not the player has moved the first direction input section 102 and the second direction input section 104 away from each other with a time difference by which it may be considered that the inputs are performed simultaneously. The game calculation section 210 may also determine that the arbitrary expansion operation has been input when the player has moved the levers away from each other with in the vertical direction.

When the game calculation section 210 has determined that the arbitrary expansion operation has been input (YES in step S34), the game calculation section 210 moves the front node 2fr (node of the head CPh) away from the adjacent connection node by the length L of the connector 4 (step S36), and adds a new node between the front node 2fr which has been moved and the adjacent connection node (step S38).

In the example shown in FIG. 9, since the node NODE1 corresponds to the front node 2fr of the player character CP, the game calculation section 210 moves the node NODE1 in the direction of the vector from the adjacent connection node NODE2 toward the node NODE1 by the length L of the connector 4. The game calculation section 210 adds appropriate node identification information (e.g., “NODE6”) to the added node, and registers the added node identification information as the skeleton model control data 525. The game calculation section 210 sets the position coordinates 525b at the intermediate position between the nodes NODE1 and NODE2 or the original position of the node NODE1. The game calculation section 210 stores “NODE1” as the head-side connection node identification information 525c, and stores “NODE2” as the tail-side connection node identification information 525d. The game calculation section 210 updates the tail-side connection node identification information 525d of the node NODE1 from “NODE2” to “NODE6”, and updates the head-side connection node identification information 525c of the node NODE2 from “NODE1” to “NODE6”. The game calculation section 210 stores “0” as the effect information 525e.

When the game calculation section 210 has added the new node to the skeleton model BM registered as the character control data 524, the game calculation section 210 moves the rear node 2rr (node of the tail CPt) away from the adjacent connection node by the length L of the connector 4 (step S40), and adds a new node between the rear node 2rr which has been moved and the adjacent connection node (step S42).

The game calculation section 210 resets the node count change permission timer 548 to “0” restarts the node count change permission timer 548 (step S44), and finishes the arbitrary expansion/contraction process.

When the game calculation section 210 has determined that the arbitrary expansion operation has not been input (NO in step S34, the game calculation section 210 determines whether or not a specific arbitrary contraction operation has been input (step S50). Specifically, the game calculation section 210 determines whether or not the player has simultaneously performed a left direction input and a right direction input respectively using the right analog lever 1236 and the left analog lever 1238. Specifically, the game calculation section 210 determines whether or not the player has moved the first direction input section 102 and the second direction input section 104 closer with a time difference by which it may be considered that the inputs are performed simultaneously. The game calculation section 210 may also determine that the arbitrary expansion operation has been input when the player has moved the levers to become closer in the vertical direction.

When the game calculation section 210 has determined that the arbitrary contraction operation has not been input (NO in step S50), the game calculation section 210 finishes the arbitrary contraction process. The game calculation section 210 also finishes the arbitrary contraction process when the total number of nodes of the skeleton model BM is two or less.

When the game calculation section 210 has determined that the arbitrary contraction operation has been input (YES in step S50), the game calculation section 210 deletes the adjacent connection node of the front node and deletes the adjacent connection node of the rear node (step S52), and moves the front node and the rear node to the positions of the deleted adjacent connection nodes (step S54).

In the example shown in FIG. 9, the game calculation section 210 deletes the nodes NODE2 and NODE4 respectively connected to the front node NODE1 and the rear node NODE5. The game calculation section 210 changes the position coordinates 525b of the node NODE1 to the value of the node NODE2, and changes the position coordinates 525b of the node NODE5 to the value of the node NODE4.

The game calculation section 210 changes the tail-side connection node identification information 525d of the node NODE1 to “NODE3”, and changes the head-side connection node identification information 525c of the node NODE3 to “NODE1”. The game calculation section 210 changes the head-side connection node identification information 525c of the node NODE5 to “NODE3”, and changes the tail-side connection node identification information 525d of the node NODE3 to “NODE5”.

The above arbitrary expansion/contraction process enables the player to arbitrarily expand/contract the player character CP.

In this embodiment, the node count change permission timer 548 is provided. When the count value has not reached a reference value (i.e., a state in which the player character CP is not expanded or contracted has not continued for a specific period of time), the player character CP is not expanded or contracted even if the player inputs the arbitrary expansion operation or the arbitrary contraction operation. This causes the expansion or contraction operation to be delayed to represent a resistance when the trunk of the player character CP slowly expands or contracts so that the player can observe a situation in which the trunk CPb expands or contracts due to growth or deformation as if the player character CP is a living thing.

When the game calculation section 210 has finished the arbitrary contraction process, the process returns to the flow in FIG. 14. The game calculation section 210 performs an applied force setting process (step S8). The applied force setting process is a process which sets the force applied to the player character CP and calculates the applied force (resultant force).

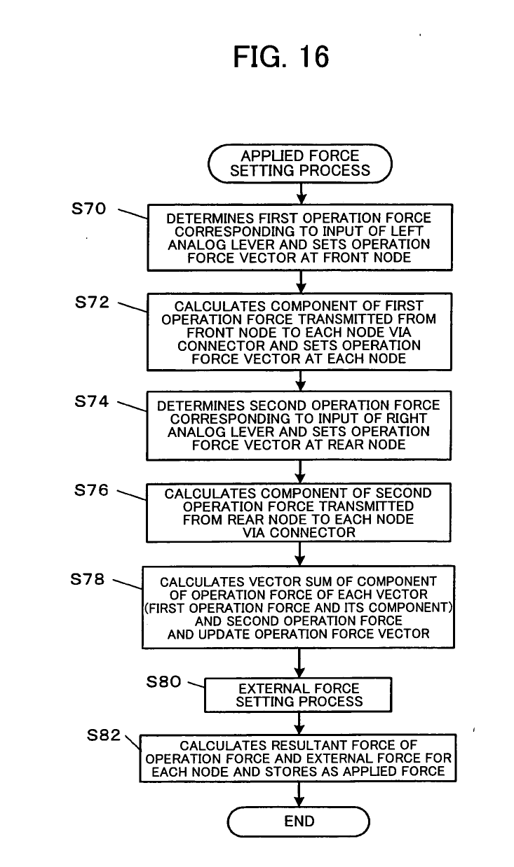

FIG. 16 is a flowchart illustrative of the flow of the applied force setting process according to this embodiment. As shown in FIG. 16, the game calculation section 210 sets the operation forces corresponding to two types of direction inputs performed by the player in the player character CP (steps S70 to 78).

Specifically, the game calculation section 210 determines the first operation force F1 (see FIGS. 3A to 3C) corresponding to the direction and the amount of tilt input using the left analog lever 1238, and sets the first operation force F1 at the front node 2fr corresponding to the head CPh of the player character CP (step S70). The game calculation section 210 calculates and sets the operation force transmitted from the front node 2fr to each node via the connector 4 in the order from the end (step S72). In the example shown in FIG. 10, the front node 2fr is the node NODE1. Therefore, the vector of the set first operation force is stored as the operation force vector 530b corresponding to the node NODE1 of the applied force vector data 530. The component of force of the first operation force vector applied to each node is calculated, and is stored as the corresponding operation force vector 530b.

The game calculation section 210 determines the second operation force F2 (see FIGS. 3A to 3C) corresponding to the direction and the amount of tilt input using the right analog lever 1236, and sets the second operation force F2 at the rear node 2rr corresponding to the tail CPt of the player character CP (step S74).

The game calculation section 210 calculates the component of the second operation force transmitted from the rear node to each node via the connector 4 in the order from the rear end (step S76). The game calculation section 210 calculates the vector sum of the component of the calculated second operation force and the vector calculated in the steps S100 and S102 and stored as the operation force vector 530b of each node to update the operation force vector 530b (step S78).

When the game calculation section 210 has set the operation force, the game calculation section 210 performs an external force setting process which sets the external force applied to the player character CP (step S80). In the external force setting process, the game calculation section 210 calculates a force set in the game space as an environmental factor such as gravity, electromagnetic force, and wind force applied to the player character CP, a force applied to the player character CP due to collision with another object, and the like for each node of the skeleton model BM, and stores the calculated force as the external force vector 530c of the applied force data 530.

When the game calculation section 210 has finished the external force setting process, the game calculation section 210 calculates the resultant force of the operation force, the external force, and a specific force for each node, stores the resultant force as the applied force data 530 (applied force vector 530d) (step S82), and finishes the applied force setting process.

When the game calculation section 210 has finished the applied force setting process, the process returns to the flow in FIG. 14. The game calculation section 210 performs a player character movement control process (step S10). The game calculation section 210 calculates the position coordinates at the next game screen drawing timing (e.g., after 1/60th of a second) in a state in which the applied force vector 530d is applied to each node and the movable condition of the skeleton model BM is maintained. The position coordinates may also be calculated using a known physical calculation process. The game calculation section 210 updates the position coordinates 525b of the skeleton model control data 525 with the calculated position coordinates.

The game calculation section 210 determines whether or not a specific period of time has expired after the photographing conditions have been changed (step S12). Specifically, the game calculation section 210 determines whether or not the value of the photographing condition change permission timer 550 is “0 (i.e., specific period of time has been measured)”, and determines that a specific time has expired when the value is “0”. The initial value of the photographing condition change permission timer 550 when starting the game is “0”. Therefore, when performing this step immediately after starting the game, the game calculation section 210 immediately transitions to the next step (YES in step S12).

When the game calculation section 210 has determined that a specific period of time has expired after the photographing conditions have been changed, the game calculation section 210 determines whether or not a new event has occurred (step S14). For example, a certain event occurs on condition that the game play time has reached a specific time after the event character CI has appeared in the game space, and the game calculation section 210 determines that the event has occurred when the game play time has reached a specific time. For example, when the event is an event in which a tree object falls upon collision with an object other than a tree so that a bridge is formed across a river, an event occurrence condition is set in advance whereby an object other than a tree collides with a tree, and the game calculation section 210 determines that the event has occurred when the condition has been satisfied. For example, a case where the player character CP is positioned within a specific distance from the event character CI which has the characters of a wild boar with a strong territorial imperative may be set to be an event occurrence condition, and an event in which the event character CPI rushes at the player character CP may be generated when the condition has been satisfied (see FIG. 7). These events are set in advance as the event setting data 532.

When the game calculation section 210 has determined that a new event has occurred (YES in step S14), the game calculation section 210 executes the new event referring to the event setting data 532 (step S15). For example, when the event is an event in which a tree object falls upon collision with an object other than a tree so that a bridge is formed across a river, the game calculation section 210 causes a tree to fall upon collision with an object other than a tree to form a bridge. For example, the game calculation section 210 executes an event in which the event character CI rushes at the player character CP on condition that the player character CP is positioned within a specific distance from the event character CI which has the characters of a wild boar with a strong territorial imperative (see FIG. 7).

The game calculation section 210 then performs an event virtual camera setting process (step S18). The event virtual camera setting process is a process which sets the event virtual camera CM4 that photographs the event character CI when an event has occurred, and controls the photographing operation when the event is executed.

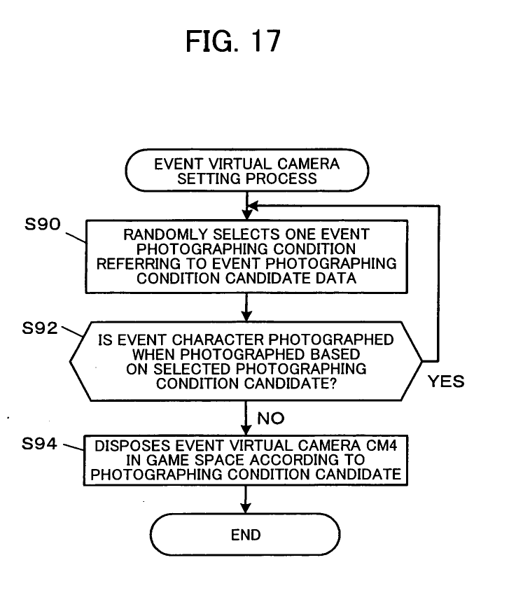

FIG. 17 is a flowchart illustrative of the flow of the event virtual camera setting process according to this embodiment. In the event virtual camera setting process, the game calculation section 210 randomly selects one of the photographing conditions 542c defined in advance referring to the event photographing condition candidate data 542 (step S90), and determines whether or not the event character CI is photographed within the photographing range when photographing the event character CI based on the selected photographing condition candidate (step S92). Specifically, the game calculation section 210 determines whether or not another object exists between the event virtual camera CM4 disposed under the selected photographing conditions and the event character IC, and determines that the event character CI is photographed within the photographing range when another object does not exist.

When the game calculation section 210 has determined that the event character CI is photographed within the photographing range (YES in step S92), the game calculation section 210 stores the selected photographing condition candidate as the photographing condition data 544 of the photographing conditions of the event virtual camera CM4, and disposes the event virtual camera CM4 in the game space (step S94). The game calculation section 210 finishes the event virtual camera setting process, and returns to the flow in FIG. 14.

When the game calculation section 210 has determined that a new event has not occurred in the step S14 in the flow in FIG. 14 (NO in step S14), the game calculation section 210 determines whether or not a completed event exists (step S16). When the game calculation section 210 has determined that a completed event exists (YES in step S16), the game calculation section 210 determines that photographing using the event virtual camera CM4 has become unnecessary, and cancels the setting of the event virtual camera CM4 (step S17). For example, when a condition whereby a specific period of time has expired after a tree has fallen is set as the event setting data 532 as a finish condition for an event in which a tree object falls upon collision with an object other than a tree so that a bridge is formed across a river, the game calculation section 210 determines whether or not the event has been completed by determining whether or not the condition is satisfied. When the game calculation section 210 has determined that a completed event does not exist (NO in step S16), the game calculation section 210 transitions to a step S24.

When the game calculation section 210 has completed the process in the step S17 or S18, the game calculation section 210 performs a main virtual camera setting process (step S20). The main virtual camera setting process is a process which calculates the photographing conditions so that the entire player character CP is always photographed, and disposes/controls the main virtual camera CM1.

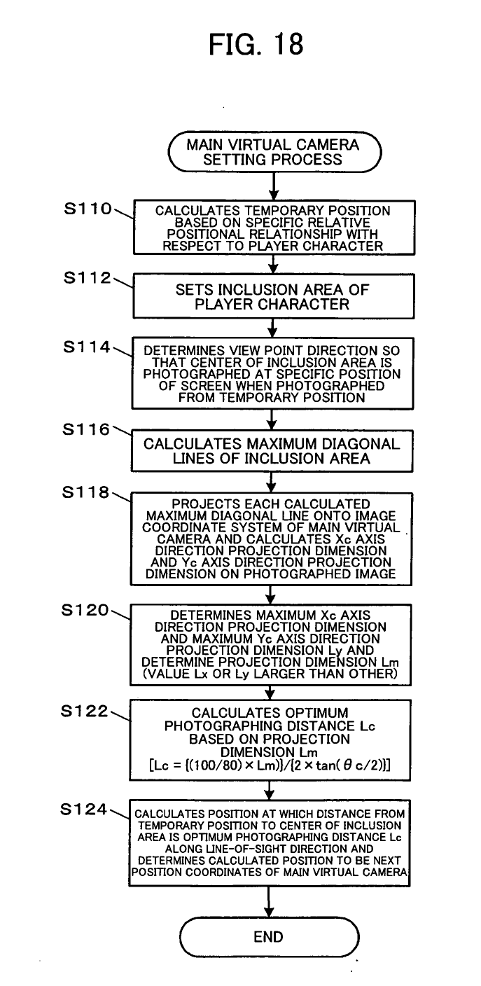

FIG. 18 is a flowchart illustrative of the flow of the main virtual camera setting process according to this embodiment. As shown in FIG. 18, the game calculation section 210 calculates the temporary position for moving the main virtual camera CM1 along with movement control of the player character CP (step S110). Specifically, the game calculation section 210 acquires a specific relative positional relationship with respect to the representative point of the player character CP referring to the virtual camera initial setting data 536 to calculate the temporary position. The game calculation section 210 calculates the temporary position so that the main virtual camera CM1 always has a specific relative position with respect to the player character CP by linearly moving the main virtual camera CM1 forward when the player character CP linearly moves forward, for example.

The determination of the temporary position is not limited to the case where the main virtual camera CM1 is moved in parallel to the player character CP. For example, when the motion of the main virtual camera CM1 has been set (e.g., the main virtual camera CM1 regularly moves to the right and left over the player character CP), the temporary position may be determined based on the motion.

When the temporary position has been determined, the game calculation section 210 adjusts the distance from the player character CP and/or the angle of view so that the entire player character CP can be photographed. In this embodiment, the game calculation section 210 sets the inclusion area 10 which includes the entire player character CP (step S112), and determines the view point direction 26 so that the center 11 of the inclusion area 10 is photographed at a specific position of the screen (e.g., center of the photographed screen) when photographed by the main virtual camera CM1 from the temporary position (step S114).

The game calculation section 210 calculates the maximum diagonal lines 12 of the inclusion area 10 (step S116), projects each calculated maximum diagonal line onto the image coordinate system of the main virtual camera CM1, and calculates the Xc axis direction projection dimension and the Yc axis direction projection dimension on the photographed image (step S118).

The game calculation section 210 determines the maximum Xc axis direction projection dimension Lx from the Xc axis direction projection dimensions calculated corresponding to the number of maximum diagonal lines 12, and determines the maximum Yc axis direction projection dimension Ly from the calculated Yc axis direction projection dimensions. The game calculation section 210 compares the determined values (Lx and Ly) to determine the projection dimension Lm which is the value Lx or Ly larger than the other (step S120).

The game calculation section 210 determines the photographing conditions so that the ratio of the projection dimension Lm to the dimension of the image (width Wx of the image when the maximum Xc axis direction projection dimension Lx is larger than the maximum Yc axis direction projection dimension Ly, or height Wy of the image when the maximum Xc axis direction projection dimension Lx is smaller than the maximum Yc axis direction projection dimension Ly) photographed by the main virtual camera along the axial direction of the selected projection dimension Lm satisfies a specific ratio (step S122).

In this embodiment, the game calculation section 210 determines the optimum photographing distance Lc of the main virtual camera CM1 from the center 11 of the inclusion area 10 so that 100:80=Wy:Ly when Ly≧Lx and 100:80=Wx:Lx when Lx>Ly (step S124). Specifically, the game calculation section 210 determines the optimum photographing distance Lc according to the equation (1).

The game calculation section 210 calculates the position at which the distance from the temporary position to the center 11 of the inclusion area 10 is the optimum photographing distance Lc along the line-of-sight direction 26, and determines the calculated position to be the next position coordinates of the main virtual camera CM1 (step S124). The photographing conditions may be determined by changing the angle of view without changing the position from the temporary position.

The photographing condition setting is not limited to the above method which calculates the optimum photographing distance Lc using a constant angle of view θc. When it is desired to maintain the relative position of the main virtual camera CM1 with respect to the player character CP, the angle of view θc may be calculated while setting the optimum photographing distance Lc to be the distance from the temporary position. Both of the optimum photographing distance Lc and the angle of view θc may be calculated. For example, when it is desired to move the main virtual camera CM1 to turn round the player character CP from the viewpoint of game production, data which defines the camera work is set in advance as the virtual camera initial setting data 536, and the angle of view θc is calculated after determining the position of the main virtual camera CM1 based on the data. Specifically, a configuration may be employed in which the optimum photographing distance Lc is determined and the angle of view θc is calculated based on the determined optimum photographing distance Lc.

When the game calculation section 210 has finished the main virtual camera setting process, the process returns to the flow in FIG. 14. The game calculation section 210 determines whether or not the player character CP is hidden when viewed from the main virtual camera CM1 (step S21). Specifically, the game calculation section 210 determines whether or not another object exists between the representative point of the main virtual camera CM1 and the representative point of the player character CP, and determines that the player character CP is hidden when another object exist between the representative point of the main virtual camera CM1 and the representative point of the player character CP. In this embodiment, the head CP and the tail CPt are used as the representative points of the player character CP. The game calculation section 210 may determine whether or not the player character CP is hidden using another method. For example, the game calculation section 210 may generate an image photographed by the main virtual camera CM1, and determine whether or not the player character CP is hidden according to specific conditions for the photographed image (e.g., whether or not the player character CP is included in the generated image, whether or not the head CP and the tail CPt are included in the generated image, and the percentage at which the player character CP is included in the generated image).

When the game calculation section 210 has determined that the player character CP is hidden (YES in step S21), the game calculation section 210 performs a sub-virtual camera setting process (step S22). The sub-virtual camera setting process is a process which disposes/controls the sub-virtual camera to always photograph a specific portion of the player character CP. In this embodiment, the term “specific portion” refers to the head CP and the tail CPt of the player character CP. Since the operation forces are applied to these portions when operating the player character CP, the field of view is ensured when operating the player character CP by photographing these portions and the peripheral situation using the sub-virtual camera.

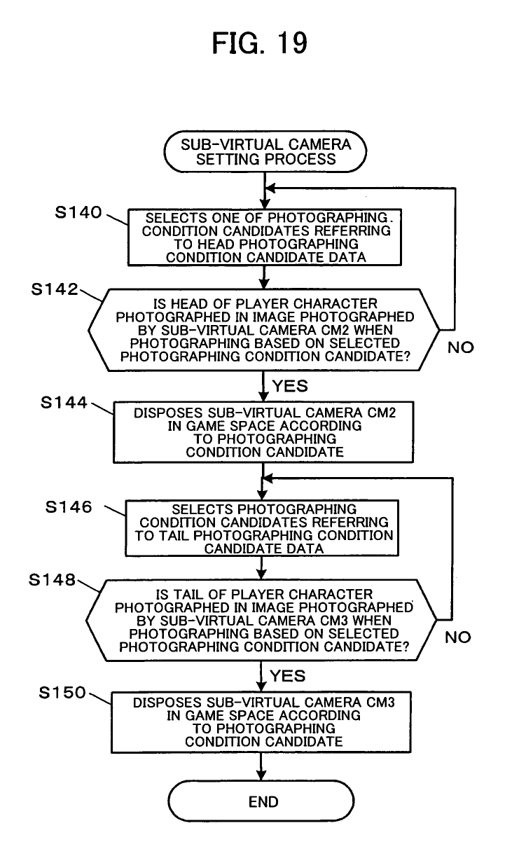

FIG. 19 is a flowchart illustrative of the flow of the sub-virtual camera setting process according to this embodiment. As shown in FIG. 19, the game calculation section 210 randomly selects one of the photographing condition candidates set in advance referring to the head photographing condition candidate data 538 (step A140). The game calculation section 210 determines whether or not the photographing target portion is photographed in the image photographed by the sub-virtual camera CM2 when photographing an image based on the selected photographing condition candidate (step S142). Specifically, the game calculation section 210 determines whether or not another object exists between the sub-virtual camera CM2 and the front node 2fr corresponding to the head CPh. When the game calculation section 210 has determined that another object exists, the game calculation section 210 determines that the photographing target portion is photographed in the image photographed by the sub-virtual camera CM2. When the game calculation section 210 has determined that the photographing target portion is not photographed in the image photographed by the sub-virtual camera CM2 (NO in step S142), the game calculation section 210 returns to the step S140 and again selects the photographing condition candidate. When the game calculation section 210 has determined that the photographing target portion is photographed in the image photographed by the sub-virtual camera CM2 (YES in step S142), the game calculation section 210 stores the selected photographing condition candidate as the photographing condition data 544 to be the photographing conditions of sub-virtual camera CM2, and disposes the virtual camera CM2 in the game space (step S144).

When the game calculation section 210 has determined the photographing conditions of the sub-virtual camera CM2, the game calculation section 210 determines the photographing conditions of the sub-virtual camera CM3 which photographs the tail CPt. Specifically, the game calculation section 210 randomly selects one of the photographing condition candidates set in advance referring to the tail photographing condition candidate data 542 (step S146), and determines whether or not the photographing target portion (tail CPt) is photographed in the image photographed by the sub-virtual camera CM3 when photographing the photographing target portion based on the selected photographing condition candidate (step S148).

When the game calculation section 210 has determined that the photographing target portion is not photographed in the image photographed by the sub-virtual camera CM3 (NO in step S148), the game calculation section 210 returns to the step S146 and again selects the photographing condition candidate. When the game calculation section 210 has determined that the photographing target portion is photographed in the image photographed by the sub-virtual camera CM3 (YES in step S148), the game calculation section 210 stores the selected photographing condition candidate as the photographing condition data 544 to be the photographing conditions of sub-virtual camera CM3, and disposes the virtual camera CM3 in the game space (step S150). The game calculation section 210 thus finishes the sub-virtual camera setting process.

In this embodiment, the head CPh and the tail CPt are partially photographed. When partially photographing three or more portions, a process similar to steps S140 to S144 may be repeated.

When the game calculation section 210 has finished the sub-virtual camera setting process, the process returns to the flow in FIG. 14. The game calculation section 210 performs a game screen display process (step S24).

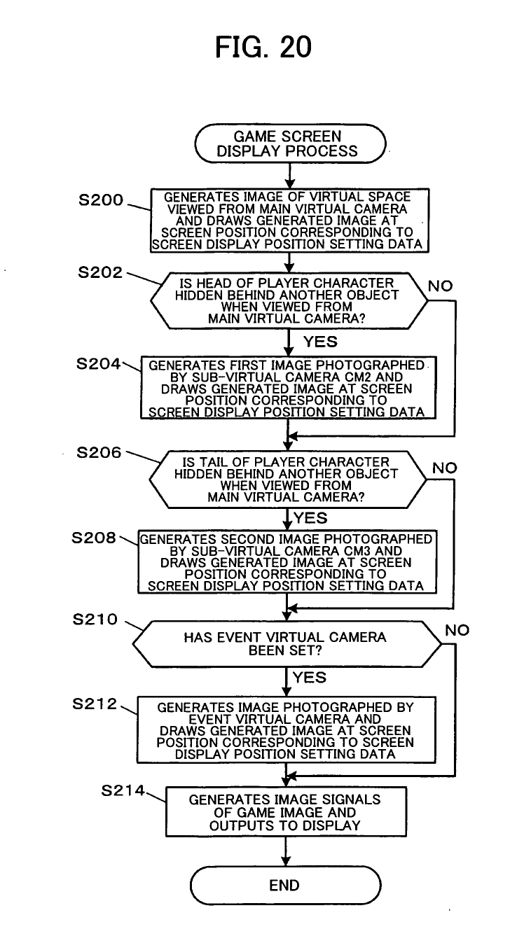

FIG. 20 is a flowchart illustrative of the flow of the game screen display process according to this embodiment. As shown in FIG. 20, the image generation section 260 generates an image of a virtual space viewed from the main virtual camera CM1, and draws the generated image at the corresponding image display range coordinates 546b stored as the screen display position setting data 546 (step S200).

The image generation section 260 determines whether or not a sub-screen display state condition is satisfied. When the image generation section 260 has determined that the sub-screen display state condition is satisfied, the image generation section 260 displays the sub-screen. Specifically, the image generation section 260 determines whether or not the head CPh of the player character CP is hidden behind another object when viewed from the main virtual camera CM1 (i.e., whether or not the head CPh is photographed in the image photographed by the main virtual camera CM1) as a first condition (step S202). The image generation section 260 determines whether or not the head CPh of the player character CP is hidden behind another object by determining whether or not the current photographing conditions of the main virtual camera CM1 satisfy the sub-screen display state condition.

When the image generation section 260 has determined that the head CPh of the player character CP is hidden behind another object (i.e., the sub-screen display state condition is satisfied) (YES in step S202), the image generation section 260 generates an image of a virtual space viewed from the sub-virtual camera CM2, and draws the generated image at the image display range coordinates 546b of the screen type 546a associated by the screen display position setting data 546 (step S204). In the initial state when starting the game, the image photographed by the sub-virtual camera CM2 is synthesized as the sub-screen W2 at a given position on the image photographed by the main virtual camera CM1 (see FIG. 7).

The image generation section 260 determines whether or not the tail CPt is hidden behind another object when viewed from the main virtual camera CM1 (step S206). When the image generation section 260 has determined that the tail CPt is hidden behind another object (YES in step S206), the image generation section 260 generates an image of a virtual space viewed from the sub-virtual camera CM3, and draws the generated image at the image display range coordinates 546b of the screen type 548a associated by the screen display position setting data 546 (step S208). In the initial state when starting the game, the image photographed by the sub-virtual camera CM3 is synthesized as the sub-screen W3 at a given position on the image photographed by the main virtual camera CM1.

The image generation section 260 determines whether or not the event virtual camera CM4 has been set referring to the photographing condition data 544 (step S210). When the image generation section 260 has determined that the event virtual camera CM4 has been set (YES in step S210), the image generation section 260 generates an image photographed by the event virtual camera CM4, and draws the generated image at the image display range coordinates 546b associated with the event virtual camera CM4 as the screen display position setting data 546 (step S212). In the initial state when starting the game, the image photographed by the event virtual camera CM4 is synthesized as the sub-screen W4 on the image photographed by the main virtual camera CM1.

When the head CPh and the tail CPt are not photographed in the photographed image due to the positional relationship with another object even if the main virtual camera CM1 is controlled to photograph the entire player character CP, photographed images of the head CPh and the tail CPt are formed and synthesized so that the sub-screens W2 and W3 are popup-displayed on the main game screen W1 (step S214). When an event has occurred and been executed, an image of the event is formed and synthesized so that the sub-screen W4 is popup-displayed (step S214).

The condition whereby the specific portions defined as the objects of the sub-virtual cameras CM2 and CM3 are not positioned within the photographing range of the main virtual camera CM1 has been given as the sub-screen display condition. The sub-screen display state condition is not limited thereto. For example, the sub-screen may be displayed on condition that the player character CP is stationary. In this case, the player can more closely observe the situation by allowing the player to easily observe the movement state of the player character CP by removing the sub-screen during movement and causing the player character CP to stop. This allows the player to more easily operate the player character CP.

The sub-screen may be displayed on condition that the total length of the player character CP is equal to or greater than a reference value, or may be displayed on condition that the player character CP is in a specific position. Moreover, the sub-screen may be displayed on condition that the player character CP acquires a specific item or casts a spell, or based on the status of a portion (e.g., a specific portion is injured or the player character CP wears an item), a game process state (e.g., the player character CP goes through a narrow place while preventing contact), the type of game stage, or the like.

When the image generation section 260 has finished the game image display process, the process returns to the flow in FIG. 14. The image generation section 260 performs an image display switch process in which the image generation section 260 changes the screen display position setting data 546 so that the image displayed on the main game screen W1 and the image displayed on the sub-screen can be changed at the next game screen drawing timing corresponding to an operation input of the player (step S26).

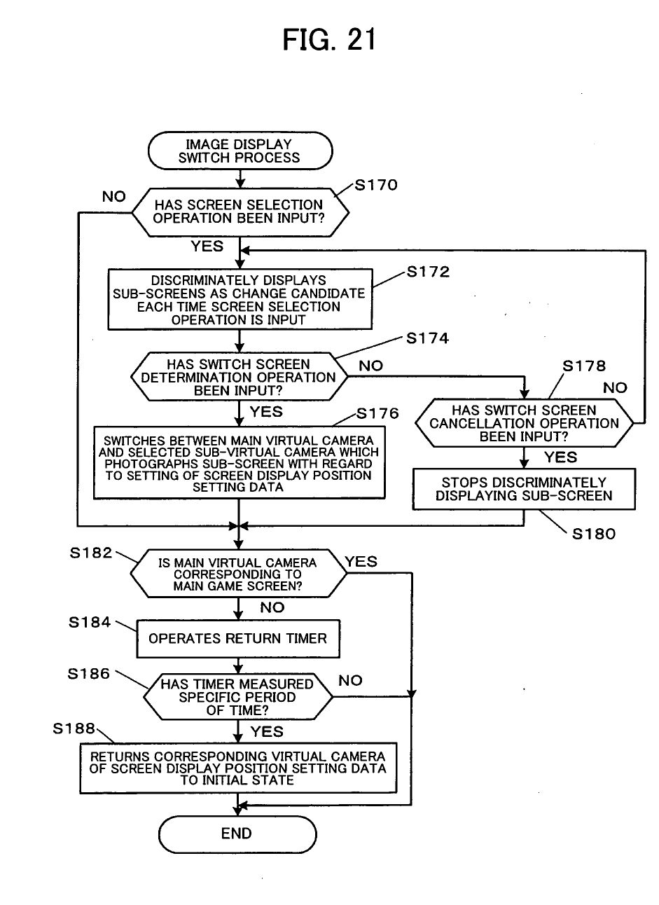

FIG. 21 is a flowchart illustrative of the flow of the image display switch process according to this embodiment. As shown in FIG. 21, the image generation section 260 determines whether or not a specific screen selection operation has been input using the game controller 1230 (step S170). For example, the image generation section 260 determines that the screen selection operation has been input when a specific push button 1232 has been pressed.

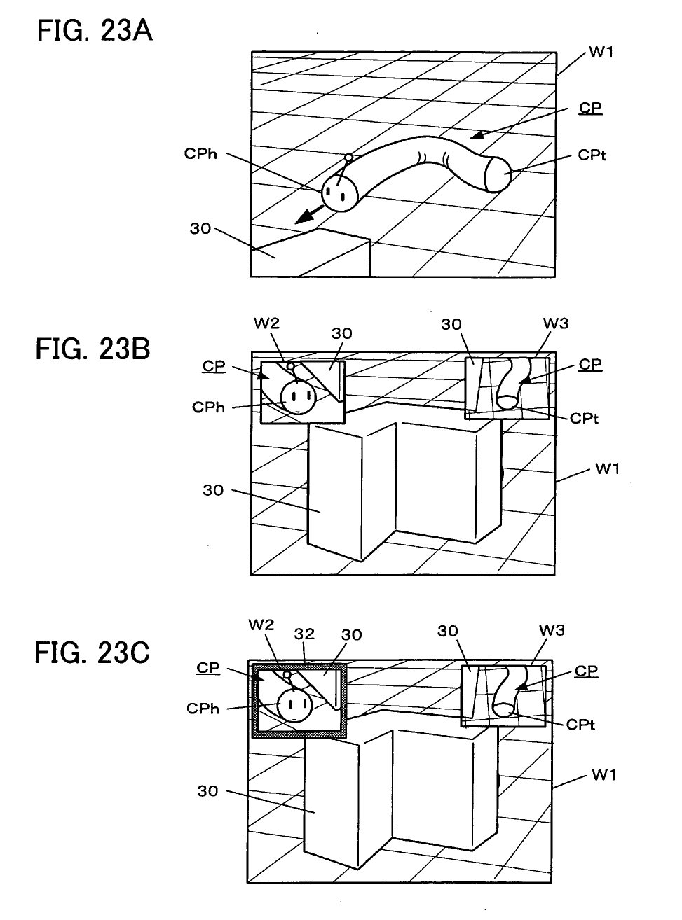

When the image generation section 260 has determined that the screen selection operation has been input (YES in step S170), the image generation section 260 discriminately displays one of the currently displayed sub-screens as a switch candidate each time the screen selection operation is input (step S172). Specifically, when the sub-screens W2 and W3 are currently displayed on the main game screen W1 (see FIG. 23B), the image generation section 260 discriminately displays the sub-screen W2 by applying a specific design to the display color, the luminance, and the display frame of the periphery of the sub-screen W2 when the screen selection operation has been input (see FIG. 23C), for example. In this state, the image generation section 260 sets the sub-screen W2 to be the switch candidate. When the screen selection button switch has been again pressed, the image generation section 260 stops discriminately displaying the sub-screen W2, and discriminately displays the sub-screen W3 as the switch candidate.

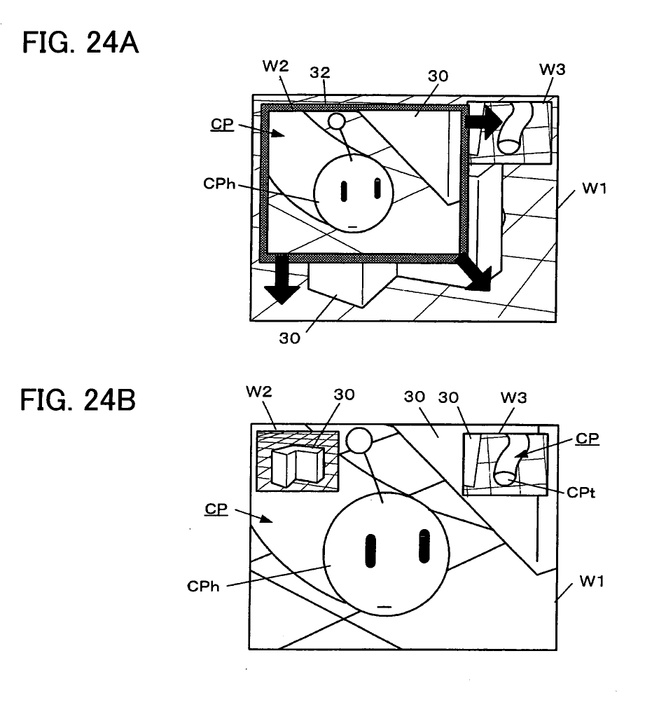

When a specific determination operation has been input using the game controller 1230 (YES in step S174), the image generation section 260 switches between the main virtual camera CM1 and the selected sub-virtual camera which photographs the sub-screen with regard to the setting of the corresponding virtual camera 546c of the screen display position setting data 546 (step S176). As a result, when the game screen display process (step S24 in FIG. 14) is performed in the next control cycle, the image displayed on the main game screen W1 and the image displayed on the sub-screen are switched (see FIG. 24). When a specific cancellation operation has been input instead of a specific determination operation (YES in step S178), the image generation section 260 stops discriminately displaying the sub-screen (step S180).

In this embodiment, the image is instantaneously changed at the next game screen drawing timing by changing the screen display position setting data 546. Note that a known screen transient process (e.g., wiping or overlapping) may be appropriately performed. In this case, it is preferable to temporarily suspend the movement control of the player character CP and other objects during the transient process.

The image generation section 260 determines whether or not the virtual camera corresponding to the main game screen W1 is the main virtual camera CM1 referring to the screen display position setting data 546 (step S182).

When the image generation section 260 has determined that the virtual camera corresponding to the main game screen W1 is not the main virtual camera CM1 (NO in step S182), the image generation section 260 operates a return timer (step S184). When the operated timer has not measured a specific period of time (NO in step S186), the image generation section 260 finishes the image display switch process. When the operated timer has measured a specific period of time (YES in step S186), the image generation section 260 returns the corresponding virtual camera 546c of the screen display position setting data 546 to the initial state (e.g., state shown in FIG. 13A) so that the image photographed by the main virtual camera CM1 is displayed on the main game screen W1 (step S188), and finishes the image display switch process.

Specifically, even if the image displayed on the main game screen W1 and the image displayed on the sub-screen are switched corresponding to the operation input of the player, the original state is automatically recovered when a specific period of time has expired. Therefore, even if the player temporarily enlarges the sub-screen which displays the head CPh or the tail CPt from the angle differing from that of the main virtual camera CM1 so that the player can easily operate the player character CP, the main virtual camera CM1 mainly photographs the entire player character CP during play, and the game screen displays the image photographed by the main virtual camera CM1 as the main screen. Since a more suitable game screen which implements operability appropriate for this game is a game screen in which the image photographed by the main virtual camera CM1 is displayed on the main game screen W1, a comfortable game play environment can be provided by automatically recovering the original image display.

When the image generation section 260 has finished the image display switch process, the process returns to the flow in FIG. 14. The game calculation section 210 determines whether or not a game finish condition is satisfied (step S28). In this embodiment, the game calculation section 210 determines that the game finish condition is satisfied when the player character has safely reached a specific goal point before the strength value becomes “0” (game clear). The game calculation section 210 also determines that the game finish condition is satisfied when the strength value has become “0” during movement (game over) due to hindrance of the event character CI or the like or falling from a high place, for example).

When the game calculation section 210 has determined that the game finish condition is not satisfied (YES in step S28), the game calculation section 210 returns to the step S4. When the game calculation section 210 has determined that the game finish condition is not satisfied (NO in step S28), the game calculation section 210 performs a game finish process to finish a series of processes.

In this embodiment, the entire player character CP is always displayed on the game screen by the above series of processes.

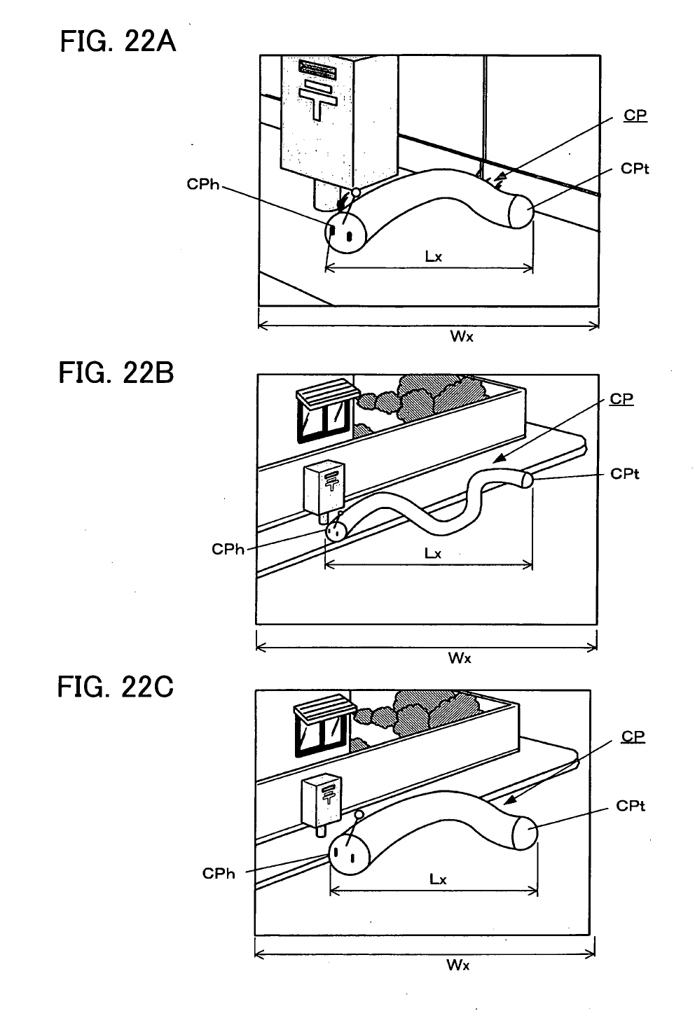

FIGS. 22A to 22C are views showing examples of an image photographed by the main virtual camera CM1 according to this embodiment. FIGS. 22A to 22C show examples which differ in the total length of the player character CP. Even if the player character CP expands from the state shown in FIG. 22A to the state shown in FIG. 22B, the photographing conditions are changed so that the main virtual camera CM1 moves away from the player character CP and that the player character CP is photographed to have a size which ensures a specific relationship with the screen. Specifically, the player character CP is photographed so that the length of the player character CP projected onto the screen coordinate system of the main virtual camera CM1 (Xc axis direction projection dimension Lx in FIGS. 22A to 22C) has a specific ratio of less than “1.0” with respect to the width of the screen (width Wx in FIGS. 22A to 22C). Therefore, the Xc axis direction projection dimensions Lx in FIGS. 22A and 22B are close values in principle.

In this embodiment, since an image photographed by the main virtual camera CM1 is basically displayed as the main game screen W1, the player can always observe the situation around the player character CP at the front end and the rear end. Therefore, the player can easily operate the player character CP. Moreover, even if the thickness of the player character CP increases as the total length of the player character CP increases, the situation around the player character CP can be displayed on the game screen at the front end and the rear end, as shown in FIG. 22C. The photographing conditions of the main virtual camera CM1 can be set using a simple process, even if the character changes into a complex shape, by determining the photographing conditions based on the inclusion area 10.

In this embodiment, the head CPh and the tail CPt can always be displayed on the game screen accompanying the movement and a change in shape of the player character CP.

FIGS. 23A to 23C and FIGS. 24A to 24C are views showing game screen examples according to this embodiment. FIGS. 23A to 23C and FIGS. 24A to 24C show a change in screen when switching the display between the main game screen W1 and the sub-screen W2. FIGS. 23A to 23C and FIGS. 24A to 24C show examples when performing a transient process.

In FIG. 23A, only the main game screen W1 is displayed. Specifically, the main virtual camera CM1 is controlled by the main virtual camera setting process to photograph the entire player character CP. Since the head CPh and the tail CPt are not hidden behind another object, the sub-screen is not displayed. Suppose that the player character CP is then moved to a position behind an obstacle 30.

When the player character CP is hidden behind the obstacle 30 when viewed from the main virtual camera CM1, the sub-screens are displayed, as shown in FIG. 23B. In FIG. 23B, since the head CPh and the tail CPt are hidden in the main game screen W1, the sub-screen W2 which shows the head CPh and the sub-screen W3 which shows the tail CPt are displayed. Since the head CPh of the player character CP is hidden earlier than the tail CPt, the head CPh is displayed first, and the tail CPt is then displayed.

When the player has input a specific screen switching operation using the game controller 1230, the selected sub-screen is discriminately displayed, as shown in FIG. 23C. In this example, the sub-screen W2 is selected, and a specific selection display frame 32 is highlighted around the image display of the sub-screen W2.

When the sub-screen W2 has been selected as the switching target, a transient process is performed between the main game screen W1 and the sub-screen W2 so that the sub-screen W2 is gradually enlarged, as shown in FIG. 24A, for example. When the sub-screen W2 has been enlarged to have a size almost equal to that of the main game screen W1, the image photographed by the sub-virtual camera CM2 is displayed on the main game screen W1, and the image photographed by the main virtual camera CM1 is displayed in the original display range of the sub image W2, as shown in FIG. 24B. In a game such as that according to this embodiment, since it is important that the player can observe the head CPh and the tail CPt when operating the player character CP, an easily playable environment can be realized by always displaying these main portions on the game screen using the sub-screen display.

According to this embodiment, the sub-screen can be displayed when an event has occurred.

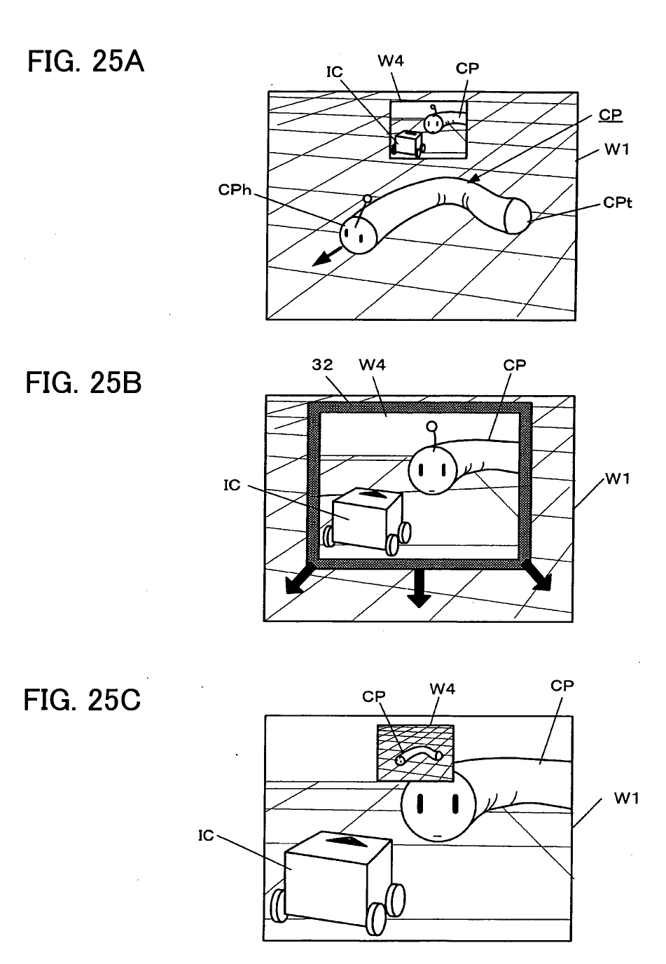

FIGS. 25A to 25C are views showing game screen examples according to this embodiment. FIGS. 25A to 25C show a change in screen when switching the display between the main game screen W1 and the sub-screen W4. As shown in FIG. 25A, when occurrence of a new event has been detected, the sub-screen W4 is displayed at a specific position of the main game screen W1. The image photographed by the event virtual camera CM4 is displayed on the sub-screen W4. In the example shown in FIG. 25A, only the player character CP is displayed on the main game screen W1. On the other hand, the sub-screen W4 displays a state in which the event character IC rushes at the player character CP.

When the player has selected the sub-screen W4 as a switch candidate in order to more closely observe the state displayed on the sub-screen W4, the sub-screen W4 is discriminately displayed and is gradually enlarged along with a transient process, as shown in FIG. 25B. When the sub-screen W4 has been enlarged to have a size almost equal to that of the main game screen W1, the image photographed by the event virtual camera CM4 is displayed on the main game screen W1, and the image photographed by the main virtual camera CM1 is displayed on the sub-screen W4, as shown in FIG. 25C.

This enables the player to more closely observe a state in which the event character IC moves toward the player character CP, so that the player can easily make a decision (e.g., avoiding direction). Specifically, the operability of the player character CP increases.

In the example shown in FIGS. 25A to 25C, the event occurs near the player character CP. Even if the event has occurred in the game space at a location away from the player character CP, the player can identify the location at which the event has occurred by displaying the event character IC and the player character CP on the sub-screen W4. Therefore, the player can easily operate the player character CP. Hardware configuration

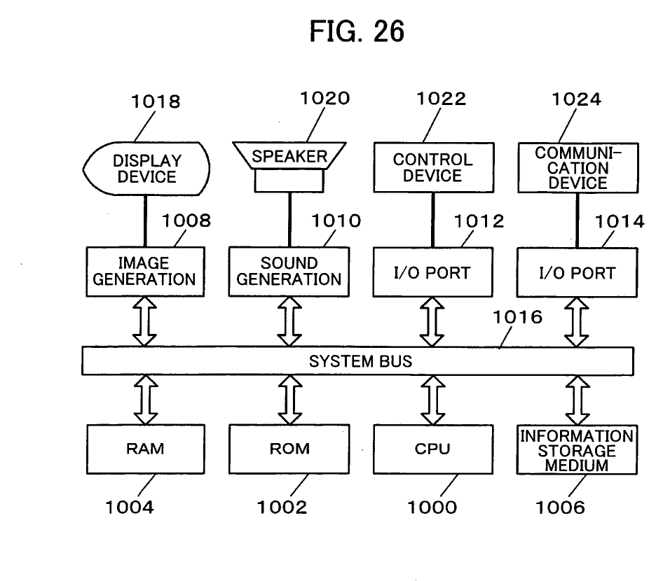

FIG. 26 is a view illustrative of an example of a hardware configuration which implements the consumer game device 1200 according to this embodiment. In the consumer game device 1200, a CPU 1000, a ROM 1002, a RAM 1004, an information storage medium 1006, an image generation IC 1008, a sound generation IC 1010, and I/O ports 1012 and 1014 are connected so that data can be input and output through a system bus 1016. A control device 1022 is connected with the I/O port 1012, and a communication device 1024 is connected with the I/O port 1014.

The CPU 1000 controls the entire device and performs various types of data processing based on a program stored in the information storage medium 1006, a system program (e.g. initialization information of the device main body) stored in the ROM 1002, a signal input from the control device 1022, and the like.

The RAM 1004 is a storage means used as a work area for the CPU 1000, and stores a given content of the information storage medium 1006 and the ROM 1002, the calculation results of the CPU 1000, and the like.

The information storage medium 1006 mainly stores a program, image data, sound data, play data, and the like. As the information storage medium, a memory such as a ROM, a hard disk, a CD-ROM, a DVD, a magnetic disk, an optical disk, or the like is used. The information storage medium 1006 corresponds to the storage section 500 shown in FIG. 8.

Sound and an image can be suitably output using the image generation IC 1008 and the sound generation IC 1010 provided in the device.

The image generation IC 1008 is an integrated circuit which generates pixel information according to instructions from the CPU 1000 based on information transmitted from the ROM 1002, the RAM 1004, the information storage medium 1006, and the like. An image signal generated by the image generation IC 1008 is output to a display device 1018. The display device 1018 is implemented by a CRT, an LCD, an ELD, a plasma display, a projector, or the like. The display device 1018 corresponds to the image display section 360 shown in FIG. 8.

The sound generation IC 1010 is an integrated circuit which generates a sound signal corresponding to the information stored in the information storage medium 1006 and the ROM 1002 and sound data stored in the RAM 1004 according to instructions from the CPU 1000. The sound signal generated by the sound generation IC 1010 is output from a speaker 1020. The speaker 1020 corresponds to the sound output section 350 shown in FIG. 8.

The control device 1022 is a device which allows the player to input a game operation. The function of the control device 1022 is implemented by hardware such as a lever, a button, and a housing. The control device 1022 corresponds to the operation input section 100 shown in FIG. 8.

A communication device 1024 exchanges information utilized in the device with the outside. The communication device 1024 is utilized to exchange given information corresponding to a program with other devices. The communication device 1024 corresponds to the communication section 370 shown in FIG. 8.

The above-described processes such as the game process are implemented by the information storage medium 1006 which stores the game program 502 and the like shown in FIG. 8, the CPU 1000, the image generation IC 1008, and the sound generation IC 1010 which operate based on these programs, and the like. The CPU 1000, the image generation IC 1008, and the sound generation IC 1010 correspond to the processing section 200 shown in FIG. 8. The CPU 1000 mainly corresponds to the game calculation section 210, the image generation IC 1008 mainly corresponds to the image generation section 260, and the sound generation IC 1010 mainly corresponds to the sound generation section 250.

The processes performed by the image generation IC 1008, the sound generation IC 1010, and the like may be executed by the CPU 1000, a general-purpose DSP, or the like by means of software. In this case, the CPU 1000 corresponds to the processing section 200 shown in FIG. 8.

### Modification

The embodiments of the invention have been described above. Note that the application of the invention is not limited to the above embodiments. Various modifications and variations may be made without departing from the spirit and scope of the invention.

For example, the above embodiments illustrate a configuration in which the video game is executed using the consumer game device as an example. Note that the game may also be executed using an arcade game device, a personal computer, a portable game device, and the like.

The above embodiments have been described taking the expansion/contraction operation of the player character as an example. Note that the invention is not limited thereto. For example, the invention may be applied to expansion/contraction control of an item used by the player character.

As the selection operation of the sub-screen as the switch candidate in the screen display switch process, the right analog lever 1236 and the left analog lever 1238 may be used instead of pressing the push button 1232.

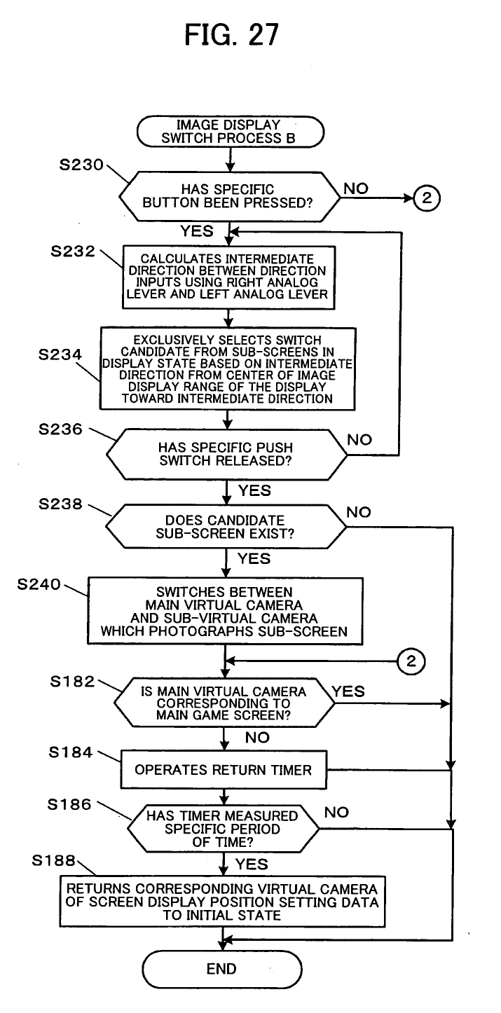

FIG. 27 is a flowchart illustrative of the flow of the screen display switch process when using the right analog lever 1236 and the left analog lever 1238 for the sub-screen selection operation, for example. The same steps as in the first embodiment are indicated by the same symbols. Description of these steps is omitted.

In FIG. 27, the image generation section 260 determines whether or not a specific push switch 1233 (see FIG. 1) which is provided on the side surface of the game controller 1230 and can be operated with a finger (e.g., forefinger) other than the thumb has been pressed (step S230). When the image generation section 260 has determined that the specific push switch 1233 has been pressed (YES in step S230), the image generation section 260 selects the sub-screen based on the input directions of the right and left analog levers.

Specifically, the image generation section 260 stores a flag which indicates display/non-display of the sub-screen in the storage section 500, and calculates the intermediate direction between two direction inputs using the right analog lever 1236 and the left analog lever 1238 (step S232). The image generation section 260 exclusively selects the sub-screen positioned in the direction from the center of the image display range of the display 1222 toward the intermediate direction from the sub-screens in a display state as the switch candidate (step S234). The image generation section 260 does not selects the switch candidate when the sub-screens in a display state do not exist.

When the specific push switch 1233 which has been pressed is released (YES in step S236), if a switch candidate sub-screen exists (YES in step S238), the image generation section 260 switches between the main virtual camera and the sub-virtual camera which photographs the sub-screen selected as the switch candidate (step S240), and transitions to the step S182. When a switch candidate sub-screen does not exist (NO in step S238), the image generation section 260 finishes the image display switch process without switching the images.

Therefore, the player can perform an arbitrary expansion/contraction operation and a movement operation of the player character CP and a switching operation of the sub-screen without removing the fingers from the right analog lever 1236 and the left analog lever 1238. This further increases operability.

A similar operation method may be implemented without performing direction inputs using the right analog lever 1236 and the left analog lever 1238.

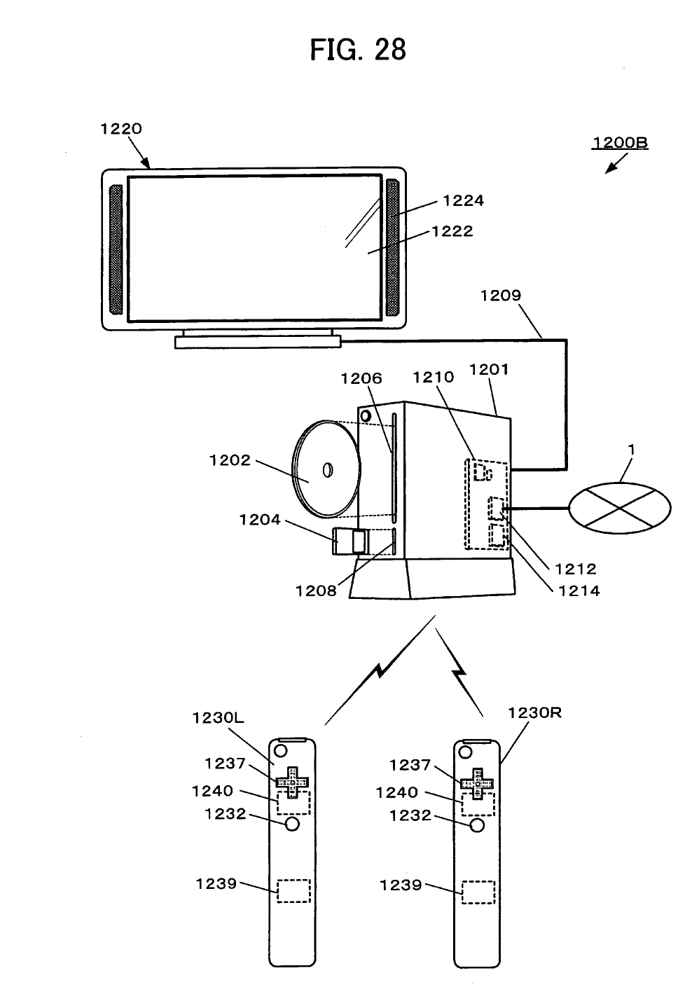

For example, a consumer game device 1200B shown in FIG. 28 is provided with game controllers 1230R and 1230L. The player holds the game controllers 1230R and 1230L with the right and left hands as if to hold a stick while placing the thumbs on arrow keys 1237 corresponding to the right analog lever 1236 and the left analog lever 1238. The game controllers 1230R and 1230L implement wireless communication with a transceiver 1214 provided in the control unit 1210 utilizing built-in transceivers 1239, and output operation input signals to the game device main body 1201.

Each of the game controllers 1230R and 1230L includes an acceleration sensor 1240. Each of the game controllers 1230R and 1230L detects an acceleration due to a change in position of each controller, and outputs the detected acceleration as the operation input signal. The forward, backward, leftward, and rightward direction inputs due to the acceleration are accelerated with the upward, downward, rightward, and leftward directions of the screen coordinate system of the display 1222 instead of using the analog lever 1236 and the left analog lever 1238. As a result, the sub-screen can be selected as a switch candidate by simultaneously shaking the game controllers 1230R and 1230L in the same direction. In this case, the player can perform an arbitrary expansion/contraction operation and a movement operation of the player character CP and a switching operation of the sub-screen without removing the thumb from the arrow key 1237.

The above embodiments have been described taking the consumer game device as an example of the video game. Note that the invention may also be applied to an arcade game device.

Although only some embodiments of the invention have been described above in detail, those skilled in the art would readily appreciate that many modifications are possible in the embodiments without materially departing from the novel teachings and advantages of the invention. Accordingly, such modifications are intended to be included within the scope of the invention.

What is claimed is:

1. A method that causes a computer to generate an image of a three-dimensional virtual space photographed by a virtual camera, a given object being disposed in the three-dimensional virtual space, the method comprising:
changing a size and/or a shape of the object;
variably setting an inclusion area that includes the object in the three-dimensional virtual space based on the change in the size and/or the shape of the object;
controlling an angle of view and/or a position of the virtual camera so that the entire inclusion area that has been set is positioned within an image photographed by the virtual camera;
generating an image of the three-dimensional virtual space photographed by the virtual camera; and
displaying the image that has been generated.

2. The method as defined in claim 1, the method further including:
determining whether a ratio of a vertical dimension of the inclusion area that has been set to a vertical dimension of the image photographed by the virtual camera is larger or smaller than a ratio of a horizontal dimension of the inclusion area to a horizontal dimension of the image photographed by the virtual camera; and
controlling the angle of view and/or the position of the virtual camera so that the ratio that has been determined to be larger than the other is a specific ratio.

3. The method as defined in claim 2,
the inclusion area being a rectangular parallelepiped; and
the determination including determining the ratio that is larger than the other based on vertical and horizontal dimensions of each of diagonal lines of the inclusion area in the image photographed by the virtual camera or a ratio of the vertical and horizontal dimensions of each of the diagonal lines to vertical and horizontal dimensions of the image photographed by the virtual camera.

4. The method as defined in claim 1, the method further including:
controlling a view point direction of the virtual camera so that a specific position of the inclusion area is located at a specific position of the image photographed by the virtual camera.

5. The method as defined in claim 1, the method further including:
controlling the angle of view and/or the position of the virtual camera at a speed lower than a change speed of the size and/or the shape of the object.

6. The method as defined in claim 1,
the object being an expandable string-shaped object; and
the method further including expanding/contracting the object.

7. The method as defined in claim 1, the method further including:
moving an end of the object based on a direction operation input, and moving the string-shaped object so that the entire object moves accompanying the movement of the end; and
variably setting the inclusion area corresponding to a current shape of the string-shaped object that has been moved.

8. A computer-readable information storage medium storing a program that causes a computer to execute the method as defined in claim 1.

9. An image generation device that generates an image of a three-dimensional virtual space photographed by a virtual camera, a given object being disposed in the three-dimensional virtual space, the image generation device comprising:
an object change control section that changes a size and/or a shape of the object;
an inclusion area setting section that variably sets an inclusion area that includes the object in the three-dimensional virtual space based on the change in the size and/or the shape of the object;
a virtual camera control section that controls an angle of view and/or a position of the virtual camera so that the entire inclusion area that has been set is positioned within an image photographed by the virtual camera;
an image generation section that generates an image of the three-dimensional virtual space photographed by the virtual camera; and
a display control section that displays the image that has been generated.

10. The image generation device as defined in claim 9,
the virtual camera control section determining whether a ratio of a vertical dimension of the inclusion area that has been set to a vertical dimension of the image photographed by the virtual camera is larger or smaller than a ratio of a horizontal dimension of the inclusion area to a horizontal dimension of the image photographed by the virtual camera, and controlling the angle of view and/or the position of the virtual camera so that the ratio that has been determined to be larger than the other is a specific ratio.

11. The image generation device as defined in claim 10,
the inclusion area being a rectangular parallelepiped; and
the virtual camera control section determining the ratio that is larger than the other based on vertical and horizontal dimensions of each of diagonal lines of the inclusion area in the image photographed by the virtual camera or a ratio of the vertical and horizontal dimensions of each of the diagonal lines to vertical and horizontal dimensions of the image photographed by the virtual camera.

12. The image generation device as defined in claim 9, the virtual camera control section controlling a view point direction of the virtual camera so that a specific position of the inclusion area is located at a specific position of the image photographed by the virtual camera.

13. The image generation device as defined in claim 9, the virtual camera control section controlling the angle of view and/or the position of the virtual camera at a speed lower than a change speed of the size and/or the shape of the object by the object change control section.

14. The image generation device as defined in claim 9,
the object being an expandable string-shaped object; and
the object change control section expanding/contracting the object.

15. The image generation device as defined in claim 9,
the image generation device further including:
an object movement control section that moves an end of the object based on a direction operation input, and moves the string-shaped object so that the entire object moves accompanying the movement of the end; and
the inclusion area setting section variably setting the inclusion area corresponding to a current shape of the string-shaped object that has been moved.
